(19) United States
(12) Patent Application Publication
(10) Pub. No.: US 2023/0272512 A1
(43) Pub. Date: Aug. 31, 2023

(54) NANOGRANULAR MAGNETIC FILM AND ELECTRONIC COMPONENT

(71) Applicant: TDK CORPORATION, Tokyo (JP)

(72) Inventors: Satoko MORI, Tokyo (JP); Hajime AMANO, Tokyo (JP); Kazuhiro YOSHIDOME, Tokyo (JP); Hiroyuki MATSUMOTO, Tokyo (JP)

(73) Assignee: TDK CORPORATION, Tokyo (JP)

(21) Appl. No.: 18/112,238

(22) Filed: Feb. 21, 2023

(30) Foreign Application Priority Data
Feb. 25, 2022 (JP) 2022-028577

(51) Int. Cl. C22C 38/10; H01F 1/147

(52) U.S. Cl. CPC C22C 38/10; H01F 1/14733; C22C 2202/02

(57) ABSTRACT

A nanogranular magnetic film comprises a structure including first phases comprised of nano-domains dispersed in a second phase. A ratio of a volume of the first phases to a total volume of the first phases and the second phase is 65% or less. A largest one of A(Fe1)/A(Fe2), A(Co1)/A(Co2), and A(Ni1)/A(Ni2) has a value of 1.20 or more and 8.00 or less, provided that a percentage of Fe in the first phases is A(Fe1), a percentage of Fe in the second phase is A(Fe2), a percentage of Co in the first phases is A(Co1), a percentage of Co in the second phase is A(Co2), a percentage of Ni in the first phases is A(Ni1), and a percentage of Ni in the second phase is A(Ni2). The first phases comprised of the nano-domains have an average size of 2 nm or more and 30 nm or less.

### TECHNICAL FIELD

The present invention relates to a nanogranular magnetic film and an electronic component.

### BACKGROUND

Recent mobile devices, such as smartphones and smartwatches, have been required to have a larger display, a larger battery capacity, a smaller size, and less weight at the same time. The requirements of having a larger display and a larger battery capacity are inconsistent with the requirements of having a smaller size and less weight. To achieve these inconsistent requirements, circuit boards have been required to have a smaller size. In particular, power supply circuits, which occupy large areas in the circuit boards, have been required to have a smaller size.

One way to reduce the size of inductors is to enable the power supply circuits to be used at higher frequencies. To enable the power supply circuits to be used at higher frequencies, switching elements included in the power supply circuits are required to be operable at higher frequencies.

In recent years, semiconductors (e.g., GaN and SiC) other than silicon have been used as semiconductors included in the switching elements.

Including the semiconductors (e.g., GaN) having excellent high-frequency properties in the switching elements enables the switching elements to operate at high frequencies. As the switching elements have become operable at high frequencies, it has become possible to increase the operating frequency of the power supply circuits. This means that the power supply circuits have become usable at higher frequencies.

As the power supply circuits have become usable at higher frequencies, small inductors that can operate at high frequencies and reduce the size of the power supply circuits have been in demand.

An optimal small inductor operable at high frequencies is a thin film inductor. The thin film inductor is manufactured by laminating a coil, a terminal, a magnetic film, and an insulating layer or the like on a substrate through semiconductor manufacturing processes. In the thin film inductor, the magnetic film is the magnetic core of the thin film inductor. Thus, properties of the thin film inductor are heavily dependent on properties of the magnetic film of the thin film inductor.

Patent Document 1 discloses an amorphous alloy having a structure in which fine particles containing a metal element are dispersed in an amorphous film made from a nitrogen compound. Such a structure may now be referred to as a nanogranular structure.

Patent Document 2 discloses a piezoelectric film containing AN as a main component and an intentionally added metal element.

Patent Document 3 discloses a nanogranular magnetic film having a structure in which nano-sized crystals are dispersed in an insulating matrix. The nano-sized crystals contain mainly a metal simple substance, an alloy, or a compound. Examples of the metal simple substance include a simple substance of Fe, a simple substance of Co, and a simple substance of Ni. Examples of the alloy include an alloy containing at least one selected from the group consisting of Fe, Co, and Ni. Examples of the compound include a compound containing at least one selected from the group consisting of Fe, Co, and Ni. The insulating matrix is made from an insulator (e.g., SiO₂ and Al₂O₃).

Nanogranular magnetic films have a higher saturation magnetic flux density (Bs) than ferrite materials. The nanogranular magnetic films further have a higher specific resistance (ρ) than normal metal materials. For having a high saturation magnetic flux density (Bs) and a high specific resistance (ρ), the nanogranular magnetic films have a high permeability even at high frequencies. Because the nanogranular magnetic films have a high permeability at high frequencies, application of the nanogranular magnetic films to high-frequency thin film components (e.g., thin film inductors) has been under consideration.

Unfortunately, although the saturation magnetic flux density (Bs) of the nanogranular magnetic films is typically higher than that of magnetic films containing typical ferrite materials, the saturation magnetic flux density (Bs) is lower than that of other typical metal magnetic films (e.g., CoZrTa or CZT films) for thin film inductors. The saturation magnetic flux density (Bs) of a magnetic film is in proportion to the volume of a magnetic core including the magnetic film and is roughly in proportion to the area of an inductor including the magnetic film. Consequently, the nanogranular magnetic films are required to have an increased saturation magnetic flux density (Bs).

Further, the thin film inductors with the nanogranular magnetic films are required to have less losses when operating at high frequencies. The smaller the specific resistance (ρ) of the nanogranular magnetic films, the larger the eddy current loss. Thus, nanogranular magnetic films with a further improved specific resistance (ρ) are in demand.
Patent Document 1: JP Patent Application Laid Open No. S60-152651
Patent Document 2: JP Patent Application Laid Open No. 2020-065160
Patent Document 3: JP Patent No. 3956061

### SUMMARY

It is an object of the present invention to provide a nanogranular magnetic film having a high saturation magnetic flux density (Bs) and a high specific resistance (ρ).

To achieve the above object, a nanogranular magnetic film according to the present invention comprises a structure including first phases comprised of nano-domains dispersed in a second phase, wherein
the first phases and the second phase comprise at least one selected from the group consisting of Fe, Co, and Ni;
the second phase comprises at least one selected from the group consisting of O, N, and F more than the first phases do;
a ratio of a volume of the first phases to a total volume of the first phases and the second phase is 65% or less;
a largest one of A(Fe1)/A(Fe2), A(Co1)/A(Co2), and A(Ni1)/A(Ni2) has a value of 1.20 or more and 8.00 or less, provided that a percentage of Fe in the first phases is A(Fe1), a percentage of Fe in the second phase is A(Fe2), a percentage of Co in the first phases is A(Co1), a percentage of Co in the second phase is A(Co2), a percentage of Ni in the first phases is A(Ni1), and a percentage of Ni in the second phase is A(Ni2); and
the first phases comprised of the nano-domains have an average size of 2 nm or more and 30 nm or less.

The first phases comprised of the nano-domains may have an average size of 2 nm or more and 15 nm or less.

The first phases may have a bcc crystal structure.

The nanogranular magnetic film may comprise Fe and Co, and {A(Co1)/A(Co2)}/{A(Fe1)/A(Fe2)}>1.05 may be satisfied.

The nanogranular magnetic film may comprise Fe and Co, and {A(Co1)/A(Co2)}/{A(Fe1)/A(Fe2)}>2.00 may be satisfied.

An electronic component according to the present invention comprises the above-mentioned nanogranular magnetic film.

### BRIEF DESCRIPTION OF THE DRAWING(S)

FIG. 1 is a schematic cross-sectional view of a nanogranular magnetic film.

FIG. 2 is a HAADF-STEM image of Sample No. 12.

FIG. 3 is a Co mapping image of Sample No. 12.

FIG. 4 is an Fe mapping image of Sample No. 12.

FIG. 5 is a Si mapping image of Sample No. 12.

FIG. 6 is an O mapping image of Sample No. 12.

### DETAILED DESCRIPTION

Hereinafter, an embodiment of the present invention will be explained with reference to the drawings.

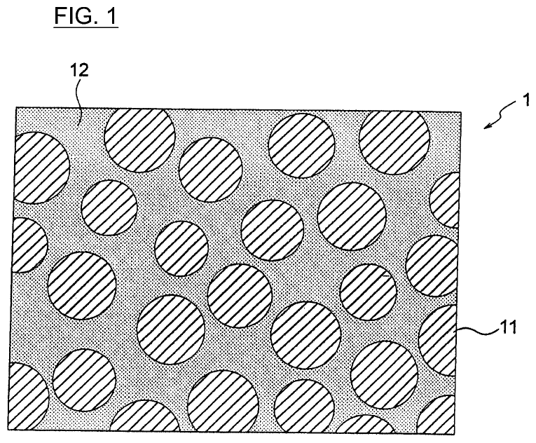

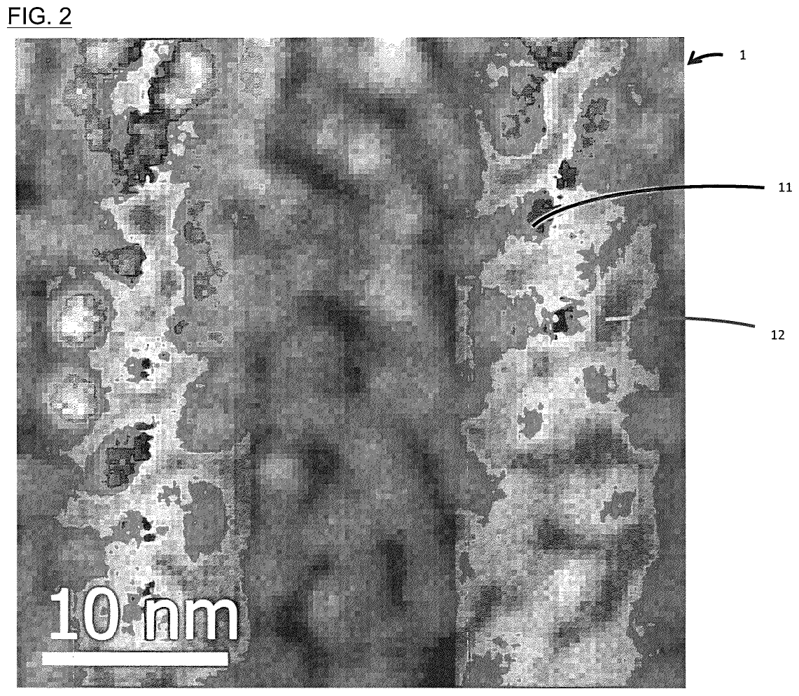

As shown in FIG. 1, a nanogranular magnetic film 1 according to the present embodiment has a nanogranular structure. In the nanogranular structure, first phases 11 (nano-domains) are dispersed in a second phase 12. By observing a cross section of the nanogranular magnetic film 1 using a scanning transmission electron microscope (STEM), a high-angle annular dark field (HAADF)-STEM image like the one shown in FIG. 2 can be acquired. The HAADF-STEM image shown in FIG. 2 is a HAADF-STEM image (magnification: 2,500,000×) of Sample No. 12 (described later).

The first phases 11 (nano-domains) have a nanoscale average size, namely an average size of 30 nm or less. The average size of the first phases 11 (nano-domains) may be 15 nm or less. The size of the respective first phases 11 (nano-domains) may be measured by any method. For example, a length in the minor axis direction of each first phase 11 (nano-domain) in a cross section of the nanogranular magnetic film 1 may be regarded as the size of the first phase 11 (nano-domain).

The first phases 11 are phases containing a metal element. Specifically, the first phases 11 contain at least one selected from the group consisting of Fe, Co, and Ni. The at least one element selected from the group consisting of Fe, Co, and Ni may be contained in the first phases 11 in any way. For example, the at least one element selected from the group consisting of Fe, Co, and Ni may be contained in the first phases 11 as a simple substance, as an alloy of the at least one element and another metal element, or as a compound of the at least one element and another element. The compound in the first phases 11 may be an oxide magnetic material, such as a ferrite.

The total amount of Fe, Co, and/or Ni in the first phases 11 is not limited to particular values. The ratio of the total amount of Fe, Co, and Ni in the first phases 11 to the total amount of Fe, Co, Ni, X1, and X2 in the first phases 11 may be 75 at % or more and may be 80 at % or more. Note that, in the calculation of the ratio, elements that occupy a larger proportion in the second phase 12 than in the first phases 11 are not regarded as part of X1 or X2.

X1 is a metalloid element. For example, X1 may be at least one metalloid element selected from the group consisting of B, Si, P, C, and Ge.

X2 is a metal element other than Fe, Co, and Ni. For example, X2 may be at least one metal element selected from the group consisting of Cr, Ti, Zr, V, Nb, Mo, Mn, Cu, Zn, Al, and Y.

The first phases 11 may contain elements other than Fe, Co, Ni, X1, and X2. In the first phases 11, the ratio of the total amount of the elements other than Fe, Co, Ni, X1, and X2 to the total amount of Fe, Co, Ni, X1, and X2 may be 5 at % or less.

Similarly to the first phases 11, the second phase 12 contains at least one selected from the group consisting of Fe, Co, and Ni. Further, the second phase 12 is a phase containing a non-metal element. Specifically, the second phase 12 may contain at least one selected from the group consisting of O, N, and F. The at least one element selected from the group consisting of O, N, and F may be contained in the second phase 12 in any way. For example, the at least one element selected from the group consisting of O, N, and F may be contained in the second phase 12 as a compound of the at least one element and another element.

The compound in the second phase 12 may be any compound. For example, the compound may be SiO₂, Al₂O₃, AlN, ZnO, MgF₂, SnO₂, GaO₂, GeO₂, and Si₃N₄Al₂O₃.

The nanogranular magnetic film 1 according to the present embodiment may contain elements that are not constituents of the first phases 11 or the second phase 12 as impurities. The impurities may occupy 5 at % or less in the total of the elements (other than O, N, and F) of the nanogranular magnetic film (100 at %).

The ratio of the volume of the first phases 11 to the total volume of the first phases 11 and the second phase 12 is 65% or less. In other words, V₁/(V₁+V₂) has a value of 0.65 or less, where V₁ is the proportion of the volume of the first phases 11 and V₂ is the proportion of the volume of the second phase 12. The value of V₁/(V₁+V₂) may be 0.60 or less. An excessively large ratio of the volume of the first phases 11 to the total volume of the first phases 11 and the second phase 12 reduces the specific resistance (ρ) of the nanogranular magnetic film, because the first phases 11 are more conductive than the second phase 12.

There is no lower limit of the ratio of the volume of the first phases 11 to the total volume of the first phases 11 and the second phase 12. The lower limit may be 30% or more. In other words, the value of V₁/(V₁+V₂) may be 0.30 or more. The value of V₁/(V₁+V₂) may be 0.38 or more or 0.40 or more. The smaller the ratio of the volume of the first phases 11 to the total volume of the first phases 11 and the second phase 12, the higher the specific resistance (ρ) and the lower the coercivity (Hc), and unfortunately the lower the saturation magnetic flux density.

In the nanogranular magnetic film 1, the first phases 11 contain the at least one metal element (Fe, Co, and/or Ni) more than the second phase 12 does. Specifically, provided that the percentage of Fe in the first phases 11 is A(Fe1), the percentage of Fe in the second phase 12 is A(Fe2), the percentage of Co in the first phases 11 is A(Co1), the percentage of Co in the second phase 12 is A(Co2), the percentage of Ni in the first phases 11 is A(Ni1), and the percentage of Ni in the second phase 12 is A(Ni2), the largest one of A(Fe1)/A(Fe2), A(Co1)/A(Co2), and A(Ni1)/A(Ni2) has a value of 1.20 or more and 8.00 or less.

The percentage of Fe is the atomic ratio of Fe to the total of the constituent elements of the compound in the second phase 12, Fe, Co, and Ni. Note that O, N, and F are not regarded as the constituent elements of the compound in the second phase 12. The same applies to the percentages of Co and Ni.

A(Z1)/A(Z2) is not taken into account, where Z is Fe, Co, and/or Ni when contained in the nanogranular magnetic film 1 at less than 5 at %. For example, when the percentage of Ni is less than 5 at %, A(Ni1)/A(Ni2) is not taken into account.

When at least one of A(Fe1)/A(Fe2), A(Co1)/A(Co2), and A(Ni1)/A(Ni2) has a value of 1.20 or more, the specific resistance (ρ) and the saturation magnetic flux density (Bs) tend to be higher than when all of A(Fe1)/A(Fe2), A(Co1)/A(Co2), and A(Ni1)/A(Ni2) have a value of less than 1.20. When the at least one of A(Fe1)/A(Fe2), A(Co1)/A(Co2), and A(Ni1)/A(Ni2) has a value exceeding 8.00, the specific resistance (ρ) tends to be not sufficiently high and the coercivity (Hc) tends to be high.

Hereinafter, a method of measuring the percentage of each element in each type of phase in the nanogranular magnetic film 1 will be explained.

First, the nanogranular magnetic film 1 is observed with a TEM or a STEM. The acquired TEM or STEM image has a resolution of 0.01 nm or more and 0.3 nm or less per pixel. The TEM image or the STEM image has a magnification of 100,000× or more and 10,000,000× or less.

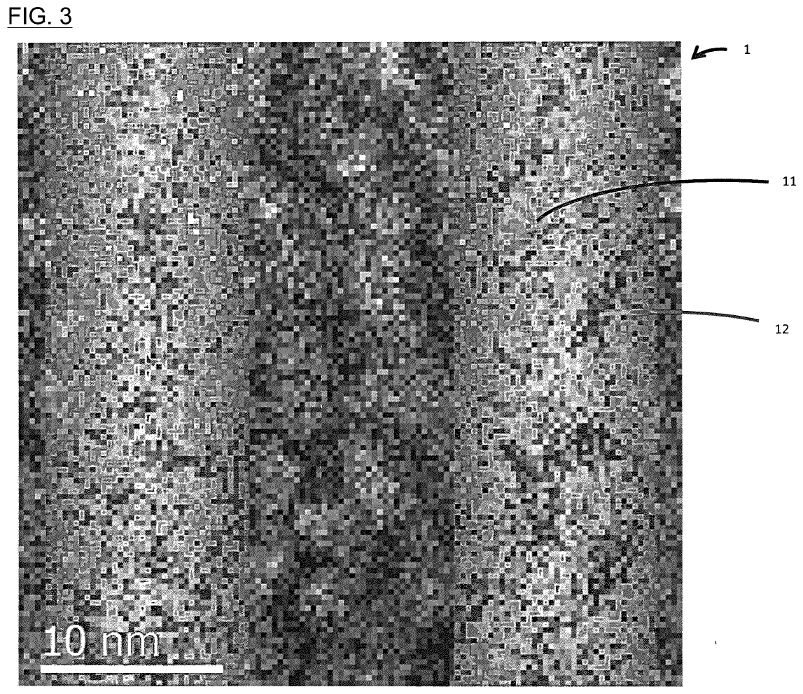

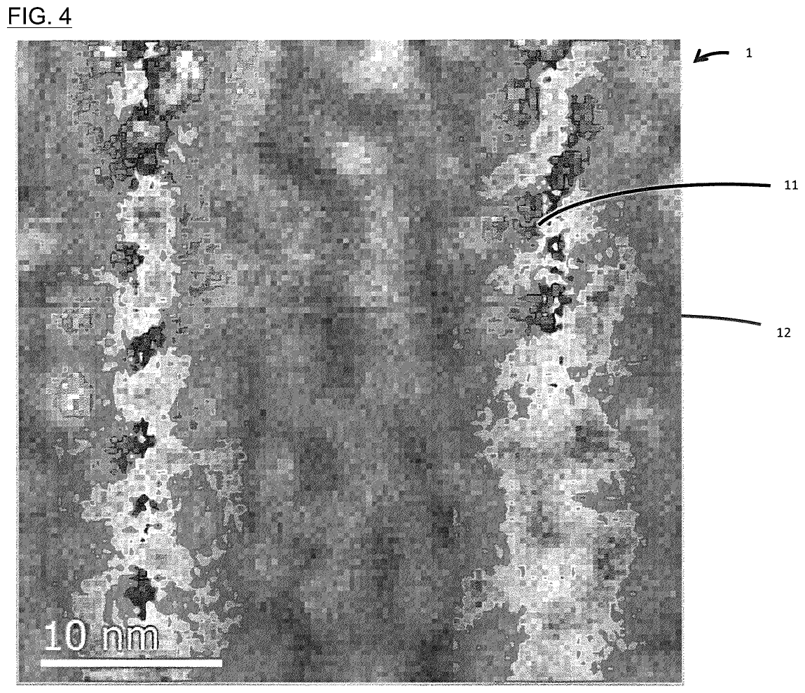

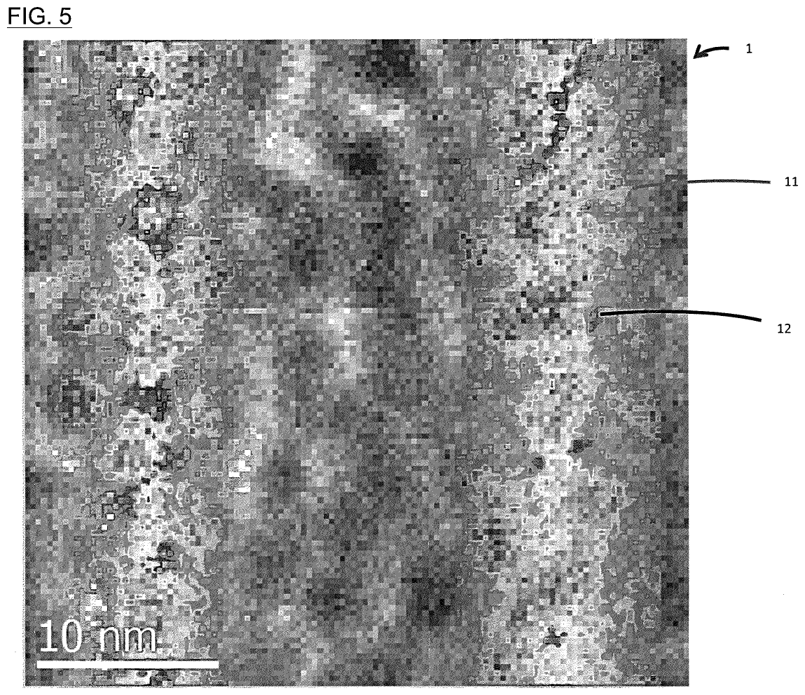

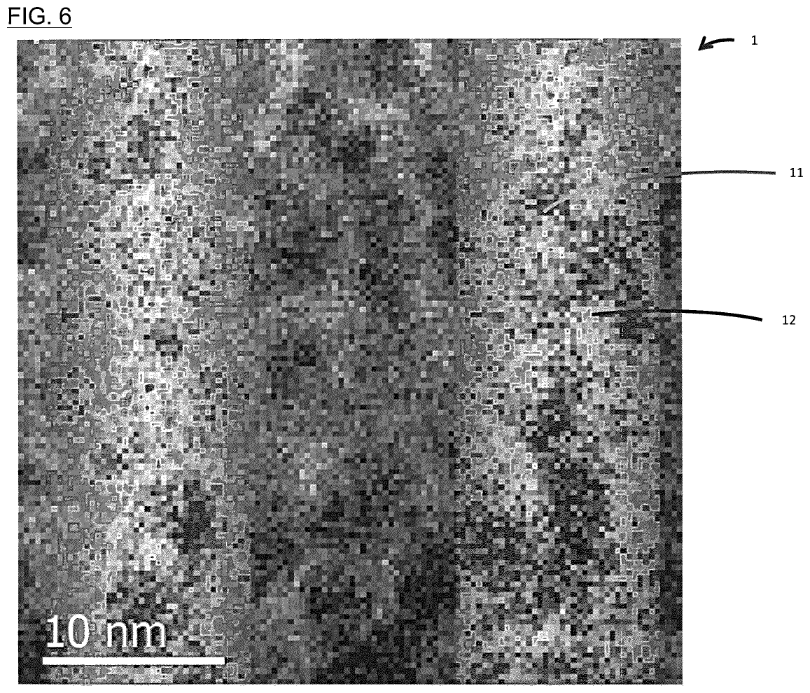

The first phases 11 and the second phase 12 are visually identified in the TEM image or the STEM image. In a bright field image, the second phase 12 tends to be brighter than the first phases 11. In a dark field image, the first phases 11 tend to be brighter than the second phase 12. As necessary, mapping images of Fe, Co, Ni, and the constituent elements of the compound in the second phase 12 may be used concurrently. FIGS. 3 to 6 exemplify mapping images of respective elements of Sample No. 12 (example) described later.

The percentages of Fe, Co, Ni, and the constituent elements of the compound in the second phase 12 in the identified first phases 11 and the identified second phase 12 are quantified to calculate A(Fe1), A(Fe2), A(Co1), A(Co2), A(Ni1), and A(Ni2). Then, the values of A(Fe1)/A(Fe2), A(Co1)/A(Co2), and A(Ni1)/A(Ni2) are calculated.

The percentage of each element in the first phases 11 may be averaged out from the percentages of that element in all first phases 11 in the nanogranular magnetic film 1. When the second phase 12 includes a plurality of second phases 12, the percentage of each element in the second phases 12 may be averaged out from the percentages of that element in all second phases 12 in the nanogranular magnetic film 1.

The percentage of each element in the identified first phases 11 and the identified second phase 12 may be quantified by any method. For example, the percentage of each element may be quantified by electron energy loss spectroscopy (EELS) at one or more measurement locations determined in the first phases 11 and one or more measurement locations determined in the second phase 12.

When two or more measurement locations are determined in the first phases 11 and two or more measurement locations are determined in the second phase 12, the quantified results may be averaged.

When the nanogranular magnetic film 1 is even, one measurement location is determined in the first phases 11 and one measurement location is determined in the second phase 12. The percentage of each element at that measurement location in the first phases 11 may be regarded as the average percentage of each element in all first phases 11. The percentage of each element at that measurement location in the second phase 12 may be regarded as the average percentage of each element in all second phases 12.

It is not required to use standard samples to quantify the percentages of Fe, Co, Ni, and the constituent elements of the compound in the second phase 12, because it is possible to accurately draw relative comparisons between different types of phases without such standard samples. In other words, provided that the same measurement apparatus is used to measure the percentages the respective elements in the first phases 11 and the percentages of the respective elements in the second phase 12 at the same time, the values of A(Fe1)/A(Fe2), A(Co1)/A(Co2), and A(Ni1)/A(Ni2) can be accurately calculated without the use of the standard samples. In contrast, the measured values of A(Fe1), A(Fe2), A(Co1), A(Co2), A(Ni1), and A(Ni2) are not highly reliable.

When the nanogranular magnetic film 1 contains Fe and Co, {A(Co1)/A(Co2)}/{A(Fe1)/A(Fe2)} has a value preferably exceeding 1.05 and more preferably exceeding 2.00. When the value of {A(Co1)/A(Co2)}/{A(Fe1)/A(Fe2)} is large, the specific resistance (ρ) and the saturation magnetic flux density (Bs) tend to be still higher.

The first phases 11 may have a crystal structure. Specifically, the first phases 11 may have a body-centered cubic (bcc) crystal structure. The bcc crystal structure readily allows the nanogranular magnetic film 1 to have a high saturation magnetic flux density (Bs). Crystals in the crystal structure of the first phases may have an average grain size of 2 nm or more and 30 nm or less and preferably 2 nm or more and 15 nm or less.

Any method may be used to check the crystal structure and the average crystal grain size. For example, the crystal structure can be checked by X-ray diffraction (XRD) pattern analysis or electron diffraction pattern analysis using a TEM or the like. For example, the average crystal grain size can be checked from a TEM image or a STEM image. The average size of the first phases 11 (nano-domains) can be regarded as the average crystal grain size.

V₁/(V₁+V₂) or the ratio of the volume of the first phases 11 to the total volume of the first phases 11 and the second phase 12 may be measured by any method. For example, the ratio can be calculated from the results of measurement of the nanogranular magnetic film 1 using XRF. The ratio may also be calculated from the ratio of the area of the first phases 11 to the total area of the first phases 11 and the second phase 12 through observation of a cross section of the nanogranular magnetic film 1 using a TEM. In this case, the ratio in terms of area is converted to the ratio in terms of volume.

The nanogranular magnetic film 1 may include only the first phases 11 and the second phase 12. The nanogranular magnetic film 1 may further include different phases other than the first phases 11 and the second phase 12. The proportion of the different phases is not limited to particular values. The different phases may occupy 10% or less of the area of a cross section of the nanogranular magnetic film 1 observed with a TEM. The different phases may partly or entirely be a void.

Although all first phases 11 are independent of another in FIG. 1, some first phases 11 may be connected.

The nanogranular magnetic film 1 may have any thickness. For example, the thickness may be 0.05 μm or more and 200 μm or less. A suitable thickness may be appropriately determined based on usage. The thickness of the nanogranular magnetic film 1 may be measured by any method. For example, the thickness can be measured with a TEM, a SEM, or a surface profiler. Also, the reliability of measurement results may be checked by correlating multiple measurement apparatuses with each other in advance.

Hereinafter, a method of manufacturing the nanogranular magnetic film according to the present embodiment will be explained.

The nanogranular magnetic film according to the present embodiment may be manufactured by any method. For example, the nanogranular magnetic film may be manufactured by sputtering.

First, a substrate on which to form the nanogranular magnetic film is prepared. The substrate may be any substrate. For example, the substrate may be a silicon substrate, a silicon substrate having a thermal oxide film, a ferrite substrate, a non-magnetic ferrite substrate, a sapphire substrate, a glass substrate, or a glass epoxy substrate. However, the substrate is not limited to these substrates. Any of various ceramic substrates or semiconductor substrates can be used. When it is difficult to check various properties using only the thin film to be formed on the substrate (sample substrate), a dummy substrate may be used as necessary. The thin film may be formed on the sample substrate and the dummy substrate simultaneously, and the properties of the thin film on the dummy substrate may be regarded as the properties of the thin film on the sample substrate.

Next, a sputtering apparatus is prepared. The sputtering apparatus is capable of multi-target simultaneous sputtering. The sputtering apparatus is further capable of changing the distance between sputtering targets and the substrate per sputtering target.

Next, a metal sputtering target and a ceramic sputtering target are prepared as the sputtering targets. The abundance ratio of Fe, Co, Ni, X1, and X2 in the metal sputtering target is about the same as the abundance ratio of Fe, Co, Ni, X1, and X2 in the first phases 11. The ceramic sputtering target is a sputtering target mainly containing the compound in the second phase 12.

Next, the metal sputtering target and the ceramic sputtering target are attached to a sputter gun for metal and a sputter gun for ceramics of the sputtering apparatus respectively. Then, the nanogranular magnetic film is formed on the substrate by multi-target simultaneous sputtering.

Controlling the voltage applied to each sputtering target can control the film deposition speed and the ratio of the volume of the first phases 11 to the total volume of the first phases 11 and the second phase 12. Note that the film deposition speed can be, for example, 1 Å/s or faster and 100 Å/s or slower.

Controlling the film deposition speed and the film deposition time can control the thickness of the nanogranular magnetic film.

The present inventors have found that controlling the distance between the ceramic sputtering target and the sample substrate can control the density of the nanogranular magnetic film. A mechanism by which the film density is controlled will be explained.

First, a noble gas (e.g., argon) is introduced into a vacuum at low pressure. Next, negative potential is applied to the sputtering targets. This generates a glow discharge or plasma. In the plasma, the noble gas atoms are ionized to produce noble gas positive ions and electrons. The noble gas positive ions are attracted electrically to the sputtering targets having negative charge and undergo elastic collision with the sputtering targets. At this time, the noble gas positive ions receive electrons from the sputtering targets to become noble gas atoms. Further, in response to the elastic collision, sputtering particles are sputtered out of the sputtering targets. These sputtering particles are deposited on the substrate to form a sputtering film.

The sputtering particles sputtered out of the sputtering targets may undergo elastic collision with the noble gas atoms in the film formation chamber while moving from the surfaces of the sputtering targets to the substrate. The sputtering particles lose their kinetic energy as they undergo elastic collision with the noble gas atoms. The higher the energy, particularly the kinetic energy, of the sputtering particles at the time of reaching the substrate, the denser the sputtering film.

The shorter the distance between the sputtering targets and the substrate, the higher the kinetic energy of the sputtering particles when they reach the substrate. Consequently, the shorter the distance between the sputtering targets and the substrate, the higher the density of the nanogranular magnetic film, resulting in densification of the sputtering film.

Also, especially when the distance between the ceramic sputtering target and the substrate is short, the density of the nanogranular magnetic film readily increases. In contrast, changing the distance between the metal sputtering target and the substrate does not readily change the film density. Consequently, bringing only the ceramic sputtering target closer to the substrate can increase the density of the nanogranular magnetic film. When the physical distance between the metal sputtering target and the ceramic sputtering target is too short, plasmas produced on each sputtering target at the time of film formation may interfere with each other and cause unstable discharge.

The distance between the ceramic sputtering target and the substrate may be changed by any method. The distance is changed by a method appropriate for the sputtering apparatus. Typically, the sputter gun for ceramics is moved to change the distance between the ceramic sputtering target and the substrate.

When only moving the sputter gun for ceramics cannot reduce the distance between the ceramic sputtering target and the substrate to an intended distance, for example, the substrate holder where the substrate is attached may be moved closer to the sputter gun for ceramics than a specified value. Also, a jig or a shutter around the substrate may be detached. Further, a spacer may be attached between a transport tray and the substrate, or an aluminum plate may be attached between the substrate and the substrate holder. In these cases, the sputter gun for metal is moved as necessary to change the distance between the sputter gun for metal and the substrate as well.

The density of the nanogranular magnetic film can be controlled as explained above. However, simply increasing the density of the nanogranular magnetic film increases its saturation magnetic flux density (Bs) but reduces its specific resistance (ρ). In contrast, reducing the density of the nanogranular magnetic film increases its specific resistance (ρ) but reduces its saturation magnetic flux density (Bs). In other words, increase of the specific resistance (ρ) of the nanogranular magnetic film and increase of the saturation magnetic flux density (Bs) thereof are in a trade-off relationship.

The present inventors have found that annealing the nanogranular magnetic film having a controlled film density causes dispersion of the metal elements and progress of separation of the compositions of the first phases 11 and the second phase 12. In other words, the present inventors have found that controlling the density of the nanogranular magnetic film can suitably control the state of diffusion of the metal elements. The present inventors have found that annealing the nanogranular magnetic film having the controlled film density allows the at least one of A(Fe1)/A(Fe2), A(Co1)/A(Co2), and A(Ni1)/A(Ni2) to have a value of 1.20 or more and 8.00 or less. The at least one of A(Fe1)/A(Fe2), A(Co1)/A(Co2), and A(Ni 1)/A(Ni2) having a value of 1.20 or more increases the resistance of the second phase 12. Thus, the nanogranular magnetic film has a high specific resistance (ρ).

As explained above, the shorter the distance between the sputtering targets and the substrate, the higher the density of the nanogranular magnetic film, and the denser the nanogranular magnetic film. The higher the density of the nanogranular magnetic film, the higher the degree of diffusion of the metal elements by annealing, and the higher the values of A(Fe1)/A(Fe2), A(Co1)/A(Co2), and A(Ni1)/A(Ni2). However, when the degree of diffusion by annealing is too high, grain growth of the crystal grains in the nanogranular magnetic film progresses excessively. This results in increase of the coercivity (Hc) of the nanogranular magnetic film. Also, when the degree of diffusion by annealing is too high, the specific resistance (ρ) of the nanogranular magnetic film decreases, because the first phases 11 connect with each other excessively.

The annealing temperature may be any temperature. The annealing temperature may be about 200° C. to about 350° C. or may be 250° C. to 350° C. The annealing time may be any amount of time and is, for example, about 0.1 to 60 minutes.

The magnetic properties of the nanogranular magnetic film may be measured by any method. For example, a vibrating sample magnetometer (VSM) can be used for measurement.

Hereinabove, one embodiment of the present invention has been explained, but the present invention is not to be limited to the embodiment.

The nanogranular magnetic film according to the present embodiment may be used for any purpose. A magnetic material including the nanogranular magnetic film is suitable for electronic components that are particularly used at a high frequency and are required to have a high saturation magnetic flux density (Bs) and a high specific resistance (ρ). Examples of the electronic components include a perpendicular recording medium, a TMR head for a magnetoresistive random access memory (MRAM), a magneto-optical element, a thin film inductor, a noise filter, and a high-frequency capacitor.

The magnetic material including the nanogranular magnetic film in the above-mentioned electronic components may have a single-layer structure including only the nanogranular magnetic film, or may have a multilayer structure including the nanogranular magnetic film and other films (e.g., SiO₂ films) containing other materials. The number of layers is not limited to particular numbers.

### EXAMPLES

Hereinafter, the present invention will be specifically explained with examples.

### Experiment 1

Two silicon substrates (6×6×0.6 mmt) each having a thermal oxide film were prepared as sample substrates for measurement with a VSM. One silicon substrate (6×6×0.6 mmt) having a thermal oxide film with a resist (length: 6 mm, width: 0.5 to 1 mm) thereon was prepared as a dummy substrate for film thickness measurement. One sapphire substrate (φ 2 inches, 0.4 mmt) was prepared as a dummy substrate for sheet resistance measurement. On each of these substrates, a nanogranular magnetic film was formed. A multi-target simultaneous sputtering apparatus (ES340 manufactured by EIKO Corporation) was used for film formation. Further details will be explained below.

In Experiment 1, a metal sputtering target made of an alloy having an atomic ratio of Fe₆₀Co₄₀ and a ceramic sputtering target made of SiO₂ were prepared as sputtering targets. Next, the sputtering targets were attached to different sputter guns.

In Experiment 1, the gas pressure of Ar during sputtering was fixed to 0.4 Pa. The distance (TS distance) between the ceramic sputtering target and the sample substrates was set to a value shown in Table 1. The distance between the metal sputtering target and the sample substrates was 90 mm.

Sputtering was performed with controlled power input to each sputtering target so that the ratio of the volume of first phases to the total volume of the first phases and a second phase was about 55% (meaning that V₁/(V₁+V₂) had a value of about 0.55) and the film deposition speed was 1.0 Å/s, to form the nanogranular magnetic film. The nanogranular magnetic film had a thickness of 300 nm.

Then, annealing was performed. Specifically, the substrates each having the nanogranular magnetic film were held at an annealing temperature shown in Table 1 for one minute. Note that annealing was not performed for Samples with no numerals in the annealing temperature column in Table 1.

The composition of the nanogranular magnetic film was checked by simple quantification of the annealed nanogranular magnetic film on one of the silicon substrates having the thermal oxide film using an EDX analyzer (manufactured by JEOL Ltd.).

The thickness of the nanogranular magnetic film was measured with a surface profiler (KLA-Tencor P-16+) that had been correlated with a TEM in advance. Specifically, the thickness of the annealed thin film on the dummy substrate for film thickness measurement was measured with the surface profiler. It was confirmed that the thickness was 300 nm as mentioned above.

The annealed nanogranular magnetic film on one of the sample substrates was measured with an XRF spectrometer (Primus IV manufactured by Rigaku Corporation) to calculate the ratio of the volume of the first phases to the total volume of the first phases and the second phase. Table 1 shows the results.

Using a TEM (JEM-2100F manufactured by JEOL Ltd.), it was confirmed that the annealed nanogranular magnetic film on one of the sample substrates of each Sample had a structure including the first phases (nano-domains) dispersed in the second phase.

The crystal structure of the first phases in the nanogranular magnetic film was checked by identifying the crystal structure of the annealed nanogranular magnetic film on one of the silicon substrates having the thermal oxide film using electron diffraction.

The average crystal grain size of the first phases (the average size of the first phases (nano-domains)) in the nanogranular magnetic film was checked with a HAADF-STEM image. The grain size in the minor axis direction was regarded as the crystal grain size. The grain sizes of at least one hundred grains in the minor axis direction were measured and averaged out. The averaged value was regarded as the average crystal grain size.

The values of A(Fe1), A(Fe2), A(Co1), and A(Co2) were measured by STEM-EELS (Quantum manufactured by Gatan, Inc.).

A measurement method using STEM-EELS will be explained. First, a sample for STEM observation was manufactured. On the annealed nanogranular magnetic film on one of the silicon substrates having the thermal oxide film, a Pt film having a thickness of 30 nm was formed by sputtering.

Next, a location from which to extract a microsample with a focused ion beam (FIB) system (NX5000 manufactured by Hitachi High-Tech Fielding Corporation) was determined. At the determined location and its surroundings, a Pt film having a thickness of 2 μm was additionally formed on the above-mentioned Pt film by electron-beam deposition and ion beam deposition.

Next, the microsample of the nanogranular magnetic film was extracted and picked out using FIB. Specifically, the substrate, the nanogranular magnetic film, and the Pt films were collectively extracted and picked out so that the extracted microsample had a rectangular shape having a length (“sample thickness”) of 1 μm on one side viewed from the thickness direction of the nanogranular magnetic film. Thus, the microsample having a sample thickness of 1 μm including the substrate, the nanogranular magnetic film, and the Pt films in this order was acquired.

The microsample having a sample thickness of 1 μm was then thinned so that the sample thickness was reduced to 10 nm or less to give the sample for STEM observation.

Next, using the sample for STEM observation, a HAADF-STEM image having a resolution of about 0.1 nm per pixel was acquired. Then, the first phases (crystal phases) and the second phase (amorphous phase) were visually identified in the HAADF-STEM image. As necessary, mapping images of Fe, Co, Si, and/or O were used concurrently. The average crystal grain size of the first phases was checked. Specifically, the average size of the first phases (nano-domains) was regarded as the average crystal grain size of the first phases.

The atomic ratio of Fe in the in the first phases to the total of Fe, Co, and Si in the first phases was measured to give A(Fe1). The atomic ratio of Co in the first phases to the total of Fe, Co, and Si in the first phases was measured to give A(Co1).

The atomic ratio of Fe in the second phase to the total of Fe, Co, and Si in the second phase was measured to give A(Fe2). The atomic ratio of Co in the second phase to the total of Fe, Co, and Si in the second phase was measured to give A(Co2).

According to the O mapping image, it was confirmed that the second phase contained O more than the first phases did in all Samples in Table 1.

The Bs and Hc values of the annealed nanogranular magnetic film on one of the sample substrates of each Sample were measured with a VSM. The magnetic properties were measured with the VSM (TM-VSM331483-HGC) manufactured by TAMAKAWA CO., LTD. at a magnetic field of −10,000 Oe to +10,000 Oe. Table 1 shows the results. The Bs value (Bs₀) of each Sample in which the film was formed on the sample substrates but annealing was not performed was measured. Then, Bs/Bs₀ was calculated as a “Bs ratio.” The Hc value (Hc₀) of each Sample in which the film was formed on the sample substrates but annealing was not performed was measured. Then, Hc/Hc₀ was calculated as a “Hc ratio.” Table 1 shows the results. The saturation magnetic flux density (Bs) was regarded as good at a Bs/Bs₀ value of 1.15 or more. The coercivity (Hc) was regarded as good at a Hc value of 5.00 Oe or less.

To calculate the specific resistance (ρ) of each Sample, the sheet resistance was measured with a resistivity meter (Loresta-EP MCP-T360 manufactured by Mitsubishi Chemical Corporation). The sheet resistance of the annealed thin film on the sapphire substrate for sheet resistance measurement was measured. The measured sheet resistance was regarded as the sheet resistance of the thin film in each experiment. Using the thickness of the thin film on the dummy substrate for film thickness measurement, the specific resistance (ρ) of each Sample was calculated.

The ρ value (ρ₀) of each Sample in which the film was formed on the sample substrates but annealing was not performed was measured. Then, ρ/ρ₀ was calculated as a “ρ ratio.” Table 1 shows the results. The specific resistance (ρ) was regarded as good at a ρ/ρ₀ value of 1.20 or more.

TABLE 1

| | | | TS | Annealing | | | A(Fe1)/ | | | A(Co1)/ |
|---|---|---|---|---|---|---|---|---|---|---|
| Sample | Example/ | V₁/ | distance | temperature | A(Fe1) | A(Fe2) | A(Fe2) | A(Co1) | A(Co2) | A(Co2) |
| No. | comparative example | (V₁ + V₂) | mm | ° C. | at % | at % | — | at % | at % | — |
| 1 | Comparative example | 0.55 | 55 | — | 49.5 | 45.8 | 1.08 | 32.9 | 29.1 | 1.13 |
| 2 | Comparative example | 0.55 | 55 | 150 | 50.2 | 45.4 | 1.11 | 33.1 | 28.5 | 1.16 |
| 3 | Comparative example | 0.55 | 55 | 300 | 55.3 | 25.1 | 2.20 | 43.2 | 3.3 | 13.09 |
| 4 | Comparative example | 0.55 | 75 | — | 49.7 | 45.3 | 1.10 | 34.0 | 30.2 | 1.13 |
| 5 | Comparative example | 0.55 | 75 | 150 | 49.5 | 44.8 | 1.10 | 34.2 | 29.9 | 1.14 |
| 6 | Comparative example | 0.55 | 75 | 300 | 54.8 | 29.2 | 1.88 | 42.2 | 4.8 | 8.79 |
| 7 | Comparative example | 0.55 | 90 | — | 49.3 | 45.3 | 1.09 | 33.3 | 30.0 | 1.11 |
| 8 | Comparative example | 0.55 | 90 | 150 | 49.9 | 45.1 | 1.11 | 33.5 | 29.7 | 1.13 |
| 9 | Comparative example | 0.55 | 90 | 300 | 54.2 | 30.8 | 1.76 | 43.0 | 4.7 | 9.15 |
| 10 | Comparative example | 0.55 | 140 | — | 49.1 | 44.5 | 1.10 | 33.4 | 29.9 | 1.12 |
| 11 | Comparative example | 0.55 | 140 | 150 | 49.7 | 44.2 | 1.12 | 33.9 | 29.5 | 1.15 |
| 12 | Example | 0.55 | 140 | 300 | 53.1 | 33.2 | 1.60 | 42.7 | 6.0 | 7.12 |
| 13 | Comparative example | 0.55 | 200 | — | 49.3 | 46.1 | 1.07 | 33.7 | 29.9 | 1.13 |
| 14 | Comparative example | 0.55 | 200 | 150 | 48.8 | 44.4 | 1.10 | 34.0 | 30.0 | 1.13 |
| 15 | Example | 0.55 | 200 | 300 | 53.1 | 38.0 | 1.40 | 42.2 | 12.8 | 3.30 |

| | | | Average | | | | | | |
|---|---|---|---|---|---|---|---|---|---|
| | | | crystal | | | | | | |
| | {A(Co1)/A(Co2)}/ | | grain | | | | | | |
| Sample | {A(Fe1)/A(Fe2)} | Crystal | size | ρ | ρ | Bs | Bs | Hc | Hc |
| No. | — | structure | nm | Ω · cm | ratio | T | ratio | Oe | ratio |
| 1 | 1.05 | bcc | 4 | 0.060 | — | 0.88 | — | 1.97 | — |
| 2 | 1.05 | bcc | 7 | 0.061 | 1.02 | 0.89 | 1.01 | 2.40 | 1.22 |
| 3 | 5.94 | bcc | 58 | 0.048 | 0.80 | 0.91 | 1.03 | 4.80 | 2.44 |
| 4 | 1.03 | bcc | 4 | 0.063 | — | 0.77 | — | 1.88 | — |
| 5 | 1.04 | bcc | 5 | 0.061 | 0.97 | 0.78 | 1.01 | 2.01 | 1.07 |
| 6 | 4.68 | bcc | 51 | 0.055 | 0.87 | 0.80 | 1.04 | 4.50 | 2.39 |
| 7 | 1.02 | bcc | 3 | 0.067 | — | 0.70 | — | 1.84 | — |
| 8 | 1.02 | bcc | 4 | 0.067 | 1.00 | 0.70 | 1.00 | 2.01 | 1.09 |
| 9 | 5.20 | bcc | 57 | 0.068 | 1.01 | 0.85 | 1.21 | 3.40 | 1.85 |
| 10 | 1.01 | bcc | 4 | 0.087 | — | 0.54 | — | 1.90 | — |
| 11 | 1.02 | bcc | 5 | 0.090 | 1.03 | 0.54 | 1.00 | 1.86 | 0.98 |
| 12 | 4.45 | bcc | 5 | 0.110 | 1.26 | 0.70 | 1.30 | 1.75 | 0.92 |
| 13 | 1.05 | bcc | 4 | 0.304 | — | 0.42 | — | 2.60 | — |
| 14 | 1.03 | bcc | 3 | 0.351 | 1.16 | 0.42 | 1.00 | 2.52 | 0.97 |
| 15 | 2.36 | bcc | 4 | 0.411 | 1.35 | 0.66 | 1.57 | 2.40 | 0.92 |

According to Table 1, in the examples in which the TS distance was longer than 90 mm and the annealing temperature was 300° C. for sufficient annealing, the larger one of A(Fe1)/A(Fe2) and A(Co1)/A(Co2) had a value of 1.20 or more and 8.00 or less and the average crystal grain size was 2 nm or more and 30 nm or less. In these examples, the p and Bs values greatly increased from those before annealing. Also, in these examples, the nanogranular magnetic film had better magnetic properties and a higher p value than the comparative examples under the same conditions except that the annealing temperature was 150° C. or less.

When the TS distance was 90 mm or less and annealing was performed at an annealing temperature of 300° C., the larger one of A(Fe1)/A(Fe2) and A(Co1)/A(Co2) had a value exceeding 8.00, which increased the coercivity (Hc). It is believed that this was because grain growth of the nanocrystals of the first phases progressed. When the TS distance was 90 mm or less and annealing was performed at an annealing temperature of 300° C., the p value and/or the Bs value did not increase sufficiently from those before annealing. It is believed that this was because the first phases connected excessively by annealing.

### Experiment 2

Experiment 2 was carried out as in Experiment 1, except that sputtering conditions were changed so as to change the ratio of the volume of the first phases to the total volume of the first phases and the second phase, i.e., V₁/(V₁+V₂). It was confirmed that, as a result, each Sample had a V₁/(V₁+V₂) value shown in Table 2. Table 2 shows the results.

TABLE 2

| | | | TS | Annealing | | | A(Fe1)/ | | | A(Co1)/ |
|---|---|---|---|---|---|---|---|---|---|---|
| Sample | Example/ | V₁/ | distance | temperature | A(Fe1) | A(Fe2) | A(Fe2) | A(Co1) | A(Co2) | A(Co2) |
| No. | comparative example | (V₁ + V₂) | mm | ° C. | at % | at % | — | at % | at % | — |
| 16 | Comparative example | 0.34 | 90 | — | 39.0 | 34.4 | 1.13 | 26.8 | 23.7 | 1.13 |
| 17 | Comparative example | 0.34 | 90 | 300 | 50.0 | 23.6 | 2.12 | 37.4 | 3.7 | 10.11 |
| 18 | Comparative example | 0.34 | 140 | — | 39.3 | 34.4 | 1.14 | 25.8 | 22.1 | 1.17 |
| 19 | Example | 0.34 | 140 | 300 | 46.1 | 24.5 | 1.88 | 37.2 | 5.0 | 7.44 |
| 20 | Comparative example | 0.38 | 90 | — | 42.2 | 37.9 | 1.11 | 29.4 | 25.5 | 1.15 |
| 21 | Comparative example | 0.38 | 90 | 300 | 48.5 | 21.2 | 2.29 | 39.3 | 4.8 | 8.19 |
| 22 | Comparative example | 0.38 | 140 | — | 41.8 | 37.2 | 1.12 | 28.6 | 24.4 | 1.17 |
| 23 | Example | 0.38 | 140 | 300 | 46.1 | 32.1 | 1.44 | 37.1 | 5.2 | 7.13 |
| 24 | Comparative example | 0.47 | 90 | — | 46.1 | 40.4 | 1.14 | 32.9 | 27.9 | 1.18 |
| 25 | Comparative example | 0.47 | 90 | 300 | 54.2 | 27.0 | 2.01 | 44.0 | 4.9 | 8.98 |
| 26 | Comparative example | 0.47 | 140 | — | 46.5 | 41.3 | 1.13 | 32.7 | 28.1 | 1.16 |
| 27 | Example | 0.47 | 140 | 300 | 53.2 | 29.5 | 1.80 | 42.2 | 6.6 | 6.39 |
| 7 | Comparative example | 0.55 | 90 | — | 49.3 | 45.3 | 1.09 | 33.3 | 30.0 | 1.11 |
| 9 | Comparative example | 0.55 | 90 | 300 | 54.2 | 30.8 | 1.76 | 43.0 | 4.7 | 9.15 |
| 10 | Comparative example | 0.55 | 140 | — | 49.1 | 44.5 | 1.10 | 33.4 | 29.9 | 1.12 |
| 12 | Example | 0.55 | 140 | 300 | 53.1 | 33.2 | 1.60 | 42.7 | 6.0 | 7.12 |
| 13 | Comparative example | 0.55 | 200 | — | 49.3 | 46.1 | 1.07 | 33.7 | 29.9 | 1.13 |
| 15 | Example | 0.55 | 200 | 300 | 53.1 | 38.0 | 1.40 | 42.2 | 12.8 | 3.30 |
| 28 | Comparative example | 0.65 | 90 | — | 54.0 | 48.4 | 1.12 | 36.8 | 32.0 | 1.15 |
| 29 | Comparative example | 0.65 | 90 | 300 | 55.2 | 24.2 | 2.28 | 43.3 | 4.7 | 9.21 |
| 30 | Comparative example | 0.65 | 140 | — | 53.2 | 46.8 | 1.14 | 35.9 | 31.0 | 1.16 |
| 31 | Example | 0.65 | 140 | 300 | 56.1 | 36.1 | 1.55 | 42.0 | 8.1 | 5.19 |
| 32 | Comparative example | 0.75 | 90 | — | 56.0 | 49.6 | 1.13 | 39.4 | 33.4 | 1.18 |
| 33 | Comparative example | 0.75 | 90 | 300 | 56.8 | 23.1 | 2.46 | 42.0 | 4.0 | 10.50 |
| 34 | Comparative example | 0.75 | 140 | — | 55.9 | 49.4 | 1.13 | 38.9 | 34.2 | 1.14 |
| 35 | Comparative example | 0.75 | 140 | 300 | 56.3 | 30.4 | 1.85 | 41.7 | 6.1 | 6.84 |

| | | | Average | | | | | | |
|---|---|---|---|---|---|---|---|---|---|
| | | | crystal | | | | | | |
| | {A(Co1)/A(Co2)}/ | | grain | | | | | | |
| Sample | {A(Fe1)/A(Fe2)} | Crystal | size | ρ | ρ | Bs | Bs | Hc | Hc |
| No. | — | structure | nm | Ω · cm | ratio | T | ratio | Oe | ratio |
| 16 | 1.00 | bcc | 4 | 30.8 | — | 0.26 | — | 0.14 | — |
| 17 | 4.77 | bcc | 55 | 20.5 | 0.67 | 0.31 | 1.19 | 0.26 | 1.86 |
| 18 | 1.02 | bcc | 4 | 62.2 | — | 0.22 | — | 0.12 | — |
| 19 | 3.95 | bcc | 5 | 75.8 | 1.22 | 0.30 | 1.36 | 0.11 | 0.92 |
| 20 | 1.04 | bcc | 5 | 10.4 | — | 0.35 | — | 0.18 | — |
| 21 | 3.58 | bcc | 56 | 11.1 | 1.07 | 0.38 | 1.09 | 0.39 | 2.17 |
| 22 | 1.04 | bcc | 4 | 19.5 | — | 0.31 | — | 0.14 | — |
| 23 | 4.97 | bcc | 6 | 24.5 | 1.26 | 0.44 | 1.42 | 0.13 | 0.93 |
| 24 | 1.03 | bcc | 6 | 1.10 | — | 0.51 | — | 0.21 | — |
| 25 | 4.47 | bcc | 52 | 1.23 | 1.12 | 0.59 | 1.16 | 0.48 | 2.29 |
| 26 | 1.03 | bcc | 5 | 1.88 | — | 0.39 | — | 0.22 | — |
| 27 | 3.55 | bcc | 6 | 2.42 | 1.29 | 0.52 | 1.33 | 0.20 | 0.91 |
| 7 | 1.02 | bcc | 3 | 0.067 | — | 0.70 | — | 1.84 | — |
| 9 | 5.20 | bcc | 57 | 0.068 | 1.01 | 0.85 | 1.21 | 3.40 | 1.85 |
| 10 | 1.01 | bcc | 4 | 0.087 | — | 0.54 | — | 1.90 | — |
| 12 | 4.45 | bcc | 5 | 0.110 | 1.26 | 0.70 | 1.30 | 1.75 | 0.92 |
| 13 | 1.05 | bcc | 4 | 0.304 | — | 0.42 | — | 2.60 | — |
| 15 | 2.36 | bcc | 4 | 0.411 | 1.35 | 0.66 | 1.57 | 2.40 | 0.92 |
| 28 | 1.03 | bcc | 5 | 0.0071 | — | 0.95 | — | 2.77 | — |
| 29 | 4.04 | bcc | 54 | 0.0069 | 0.97 | 1.17 | 1.23 | 3.76 | 1.36 |
| 30 | 1.02 | bcc | 4 | 0.0090 | — | 0.87 | — | 2.95 | — |
| 31 | 3.34 | bcc | 6 | 0.0125 | 1.39 | 1.21 | 1.39 | 2.87 | 0.97 |
| 32 | 1.04 | bcc | 4 | 0.000094 | — | 1.30 | — | 19.52 | — |
| 33 | 4.27 | bcc | 56 | 0.000098 | 1.04 | 1.49 | 1.15 | 24.80 | 1.27 |
| 34 | 1.01 | bcc | 5 | 0.000099 | — | 1.19 | — | 22.09 | — |
| 35 | 3.69 | bcc | 34 | 0.000082 | 0.83 | 1.36 | 1.14 | 26.85 | 1.22 |

According to Table 2, in the examples in which the TS distance was longer than 90 mm and the annealing temperature was 300° C. for sufficient annealing, the larger one of A(Fe1)/A(Fe2) and A(Co1)/A(Co2) had a value of 1.20 or more and 8.00 or less and the average crystal grain size was 2 nm or more and 30 nm or less. In these examples, the p and Bs values greatly increased from those before annealing.

In the examples in which the ratio of the volume of the first phases to the total volume of the first phases and the second phase was 65% or less, the coercivity (Hc) of the nanogranular magnetic film was 5.00 Oe or less. In other words, it was confirmed that use of the nanogranular magnetic films according to these examples would allow a thin film inductor to have less losses. In contrast, the coercivity (Hc) of the nanogranular magnetic films according to the comparative examples in which the ratio exceeded 65% was larger than 5.00 Oe regardless of whether annealing was performed. This implied that it would be difficult to manufacture a thin film inductor having less losses using the nanogranular magnetic films according to the comparative examples in which the ratio of the volume of the first phases to the total volume of the first phases and the second phase was too large.

### Experiment 3

Experiment 3 was carried out as in Experiment 1, except that the ceramic sputtering target was changed to change the compound in the second phase as shown in Table 3. Table 3 shows the results. Note that, because the compound in the second phase was changed, it may be that the ratio of the volume of the first phases to the total volume of the first phases and the second phase slightly deviated from 55%.

TABLE 3

| | | Second | | TS | Annealing | | | A(Fe1)/ | | |
|---|---|---|---|---|---|---|---|---|---|---|
| Sample | Example/ | phase | V₁/ | distance | temperature | A(Fe1) | A(Fe2) | A(Fe2) | A(Co1) | A(Co2) |
| No. | comparative example | compound | (V₁ + V₂) | mm | ° C. | at % | at % | — | at % | at % |
| 36 | Comparative example | Al₂O₃ | 0.56 | 90 | — | 44.2 | 39.2 | 1.13 | 29.8 | 25.3 |
| 37 | Comparative example | Al₂O₃ | 0.56 | 90 | 300 | 53.8 | 26.5 | 2.03 | 42.5 | 4.1 |
| 38 | Comparative example | Al₂O₃ | 0.56 | 140 | — | 43.4 | 38.8 | 1.12 | 30.8 | 26.0 |
| 39 | Example | Al₂O₃ | 0.56 | 140 | 300 | 52.2 | 28.4 | 1.84 | 40.3 | 5.1 |
| 40 | Comparative example | AlN | 0.53 | 90 | — | 43.3 | 37.4 | 1.16 | 28.2 | 24.2 |
| 41 | Comparative example | AlN | 0.53 | 90 | 300 | 46.7 | 34.8 | 1.34 | 39.4 | 4.7 |
| 42 | Comparative example | AlN | 0.53 | 140 | — | 43.2 | 38.7 | 1.12 | 29.1 | 25.0 |
| 43 | Example | AlN | 0.53 | 140 | 300 | 45.1 | 36.2 | 1.25 | 38.1 | 11.5 |
| 7 | Comparative example | SiO₂ | 0.55 | 90 | — | 49.3 | 45.3 | 1.09 | 33.7 | 29.1 |
| 9 | Comparative example | SiO₂ | 0.55 | 90 | 300 | 54.2 | 30.8 | 1.76 | 43.0 | 4.7 |
| 10 | Comparative example | SiO₂ | 0.55 | 140 | — | 49.1 | 44.5 | 1.10 | 34.3 | 29.3 |
| 12 | Example | SiO₂ | 0.55 | 140 | 300 | 53.1 | 33.2 | 1.60 | 42.7 | 6.0 |
| 44 | Comparative example | ZnO | 0.55 | 90 | — | 44.1 | 40.9 | 1.08 | 30.0 | 26.2 |
| 45 | Comparative example | ZnO | 0.55 | 90 | 300 | 49.6 | 30.9 | 1.61 | 41.8 | 4.7 |
| 46 | Comparative example | ZnO | 0.55 | 140 | — | 44.5 | 41.1 | 1.08 | 30.8 | 26.9 |
| 47 | Example | ZnO | 0.55 | 140 | 300 | 50.4 | 33.6 | 1.50 | 37.3 | 8.2 |
| 48 | Comparative example | MgF₂ | 0.54 | 90 | — | 47.9 | 43.1 | 1.11 | 32.3 | 27.6 |
| 49 | Comparative example | MgF₂ | 0.54 | 90 | 300 | 52.0 | 34.1 | 1.52 | 46.8 | 5.7 |
| 50 | Comparative example | MgF₂ | 0.54 | 140 | — | 48.1 | 42.7 | 1.13 | 33.2 | 28.1 |
| 51 | Example | MgF₂ | 0.54 | 140 | 300 | 52.1 | 37.1 | 1.40 | 42.6 | 11.1 |
| 52 | Comparative example | SnO₂ | 0.55 | 90 | — | 49.0 | 45.4 | 1.08 | 32.8 | 29.0 |
| 53 | Comparative example | SnO₂ | 0.55 | 90 | 300 | 51.0 | 38.2 | 1.34 | 47.1 | 5.7 |
| 54 | Comparative example | SnO₂ | 0.55 | 140 | — | 48.7 | 45.4 | 1.07 | 33.0 | 29.4 |
| 55 | Example | SnO₂ | 0.55 | 140 | 300 | 52.7 | 40.1 | 1.31 | 43.3 | 11.6 |
| 56 | Comparative example | GaO₂ | 0.56 | 90 | — | 46.3 | 41.2 | 1.12 | 31.6 | 27.4 |
| 57 | Comparative example | GaO₂ | 0.56 | 90 | 300 | 52.2 | 32.7 | 1.60 | 43.3 | 4.7 |
| 58 | Comparative example | GaO₂ | 0.56 | 140 | — | 46.1 | 41.8 | 1.10 | 32.1 | 27.5 |
| 59 | Example | GaO₂ | 0.56 | 140 | 300 | 50.9 | 35.3 | 1.44 | 40.8 | 7.6 |
| 60 | Comparative example | GeO₂ | 0.55 | 90 | — | 50.7 | 46.5 | 1.09 | 35.6 | 30.8 |
| 61 | Comparative example | GeO₂ | 0.55 | 90 | 300 | 52.7 | 29.5 | 1.79 | 46.0 | 5.5 |
| 62 | Comparative example | GeO₂ | 0.55 | 140 | — | 50.9 | 45.8 | 1.11 | 34.7 | 30.5 |
| 63 | Example | GeO₂ | 0.55 | 140 | 300 | 54.1 | 30.3 | 1.79 | 40.7 | 10.6 |
| 64 | Comparative example | Si₃N₄•Al₂O₃ | 0.55 | 90 | — | 44.8 | 40.2 | 1.11 | 29.1 | 24.6 |
| 65 | Comparative example | Si₃N₄•Al₂O₃ | 0.55 | 90 | 300 | 51.6 | 36.9 | 1.40 | 37.9 | 4.1 |
| 66 | Comparative example | Si₃N₄•Al₂O₃ | 0.55 | 140 | — | 44.6 | 39.7 | 1.12 | 29.3 | 25.0 |
| 67 | Example | Si₃N₄•Al₂O₃ | 0.55 | 140 | 300 | 50.2 | 37.3 | 1.35 | 35.5 | 7.3 |

| | | | | Average | | | | | | |
|---|---|---|---|---|---|---|---|---|---|---|
| | | | | crystal | | | | | | |
| | A(Co1)/ | {A(Co1)/A(Co2)}/ | | grain | | | | | | |
| Sample | A(Co2) | {A(Fe1)/A(Fe2)} | Crystal | size | ρ | ρ | Bs | Bs | Hc | Hc |
| No. | — | — | structure | nm | Ω · cm | ratio | T | ratio | Oe | ratio |
| 36 | 1.18 | 1.04 | bcc | 4 | 0.072 | — | 0.75 | — | 1.88 | — |
| 37 | 10.37 | 5.11 | bcc | 51 | 0.082 | 1.14 | 0.84 | 1.12 | 3.75 | 1.99 |
| 38 | 1.18 | 1.06 | bcc | 4 | 0.131 | — | 0.62 | — | 2.12 | — |
| 39 | 7.90 | 4.30 | bcc | 5 | 0.177 | 1.35 | 0.92 | 1.48 | 1.97 | 0.93 |
| 40 | 1.17 | 1.01 | bcc | 5 | 0.065 | — | 0.71 | — | 1.82 | — |
| 41 | 8.38 | 6.25 | bcc | 55 | 0.072 | 1.11 | 0.81 | 1.14 | 3.57 | 1.96 |
| 42 | 1.16 | 1.04 | bcc | 6 | 0.102 | — | 0.57 | — | 1.97 | — |
| 43 | 3.31 | 2.66 | bcc | 6 | 0.124 | 1.22 | 0.81 | 1.42 | 1.93 | 0.98 |
| 7 | 1.16 | 1.06 | bcc | 3 | 0.067 | — | 0.70 | — | 1.84 | — |
| 9 | 9.15 | 5.20 | bcc | 57 | 0.068 | 1.01 | 0.85 | 1.21 | 3.40 | 1.85 |
| 10 | 1.17 | 1.06 | bcc | 4 | 0.087 | — | 0.54 | — | 1.90 | — |
| 12 | 7.12 | 4.45 | bcc | 5 | 0.110 | 1.26 | 0.70 | 1.30 | 1.75 | 0.92 |
| 44 | 1.15 | 1.06 | bcc | 4 | 0.058 | — | 0.69 | — | 1.74 | — |
| 45 | 8.89 | 5.54 | bcc | 36 | 0.061 | 1.05 | 0.80 | 1.16 | 3.53 | 2.03 |
| 46 | 1.14 | 1.06 | bcc | 5 | 0.094 | — | 0.57 | — | 1.89 | — |
| 47 | 4.55 | 3.03 | bcc | 7 | 0.116 | 1.23 | 0.88 | 1.54 | 1.79 | 0.95 |
| 48 | 1.17 | 1.05 | bcc | 3 | 0.034 | — | 0.67 | — | 1.71 | — |
| 49 | 8.21 | 5.38 | bcc | 42 | 0.032 | 0.94 | 0.82 | 1.22 | 2.58 | 1.51 |
| 50 | 1.18 | 1.05 | bcc | 4 | 0.049 | — | 0.57 | — | 1.90 | — |
| 51 | 3.84 | 2.73 | bcc | 4 | 0.060 | 1.22 | 0.80 | 1.40 | 1.75 | 0.92 |
| 52 | 1.13 | 1.05 | bcc | 6 | 0.077 | — | 0.69 | — | 1.77 | — |
| 53 | 8.26 | 6.19 | bcc | 48 | 0.080 | 1.04 | 0.85 | 1.23 | 3.06 | 1.73 |
| 54 | 1.12 | 1.05 | bcc | 6 | 0.124 | — | 0.58 | — | 1.92 | — |
| 55 | 3.73 | 2.84 | bcc | 8 | 0.152 | 1.23 | 0.86 | 1.48 | 1.86 | 0.97 |
| 56 | 1.15 | 1.03 | bcc | 4 | 0.061 | — | 0.68 | — | 1.84 | — |
| 57 | 9.21 | 5.77 | bcc | 52 | 0.059 | 0.97 | 0.74 | 1.09 | 3.40 | 1.85 |
| 58 | 1.17 | 1.06 | bcc | 6 | 0.097 | — | 0.57 | — | 1.90 | — |
| 59 | 5.37 | 3.72 | bcc | 6 | 0.125 | 1.29 | 0.77 | 1.35 | 1.75 | 0.92 |
| 60 | 1.16 | 1.06 | bcc | 5 | 0.064 | — | 0.67 | — | 1.74 | — |
| 61 | 8.36 | 4.68 | bcc | 44 | 0.069 | 1.08 | 0.78 | 1.16 | 3.36 | 1.93 |
| 62 | 1.14 | 1.02 | bcc | 4 | 0.101 | — | 0.59 | — | 1.85 | — |
| 63 | 3.84 | 2.15 | bcc | 5 | 0.131 | 1.30 | 0.81 | 1.37 | 1.80 | 0.97 |
| 64 | 1.18 | 1.06 | bcc | 5 | 0.064 | — | 0.70 | — | 1.81 | — |
| 65 | 9.24 | 6.61 | bcc | 32 | 0.066 | 1.03 | 0.82 | 1.17 | 3.42 | 1.89 |
| 66 | 1.17 | 1.04 | bcc | 7 | 0.101 | — | 0.58 | — | 1.93 | — |
| 67 | 4.86 | 3.61 | bcc | 8 | 0.137 | 1.36 | 0.79 | 1.36 | 1.84 | 0.95 |

According to Table 3, in the examples in which the TS distance was longer than 90 mm and the annealing temperature was 300° C. for sufficient annealing, the larger one of A(Fe1)/A(Fe2) and A(Co1)/A(Co2) had a value of 1.20 or more and 8.00 or less and the average crystal grain size was 2 nm or more and 30 nm or less, even when the compound in the second phase was changed. In these examples, the p and Bs values greatly increased from those before annealing.

### Experiment 4

Experiment 4 was carried out under the same conditions as in Sample Nos. 10 to 12 of Experiment 1, except that the annealing temperature was changed. Table 4 shows the results. Note that, in all Samples shown in Table 4, it was confirmed that the value of V₁/(V₁+V₂) was 0.55.

TABLE 4

| | | TS | Annealing | | | A(Fe1)/ | | | A(Co1)/ |
|---|---|---|---|---|---|---|---|---|---|
| Sample | Example/ | distance | temperature | A(Fe1) | A(Fe2) | A(Fe2) | A(Co1) | A(Co2) | A(Co2) |
| No. | comparative example | mm | ° C. | at % | at % | — | at % | at % | — |
| 10 | Comparative example | 140 | — | 49.1 | 44.5 | 1.10 | 33.4 | 29.9 | 1.12 |
| 11 | Comparative example | 140 | 150 | 49.7 | 44.2 | 1.12 | 33.9 | 29.5 | 1.15 |
| 68 | Example | 140 | 200 | 49.7 | 43.9 | 1.13 | 35.4 | 29.4 | 1.20 |
| 69 | Example | 140 | 250 | 50.7 | 43.1 | 1.18 | 39.7 | 16.6 | 2.39 |
| 12 | Example | 140 | 300 | 53.1 | 33.2 | 1.60 | 42.7 | 6.0 | 7.12 |
| 70 | Example | 140 | 325 | 53.4 | 32.0 | 1.67 | 43.0 | 5.7 | 7.54 |
| 71 | Example | 140 | 350 | 54.1 | 30.9 | 1.75 | 43.9 | 5.6 | 7.99 |
| 72 | Comparative example | 140 | 375 | 54.4 | 30.5 | 1.78 | 44.5 | 4.4 | 10.11 |

| | | | Average | | | | | | |
|---|---|---|---|---|---|---|---|---|---|
| | | | crystal | | | | | | |
| | {A(Co1)/A(Co2)}/ | | grain | | | | | | |
| Sample | {A(Fe1)/A(Fe2)} | Crystal | size | ρ | ρ | Bs | Bs | Hc | Hc |
| No. | — | structure | nm | Ω · cm | ratio | T | ratio | Oe | ratio |
| 10 | 1.01 | bcc | 4 | 0.087 | — | 0.54 | — | 1.90 | — |
| 11 | 1.02 | bcc | 5 | 0.090 | 1.03 | 0.54 | 1.00 | 1.86 | 0.98 |
| 68 | 1.06 | bcc | 5 | 0.104 | 1.20 | 0.63 | 1.17 | 1.79 | 0.96 |
| 69 | 2.03 | bcc | 5 | 0.107 | 1.23 | 0.68 | 1.26 | 1.77 | 0.95 |
| 12 | 4.45 | bcc | 5 | 0.110 | 1.26 | 0.70 | 1.30 | 1.75 | 0.92 |
| 70 | 4.52 | bcc | 15 | 0.145 | 1.67 | 0.73 | 1.35 | 2.50 | 1.32 |
| 71 | 4.48 | bcc | 30 | 0.109 | 1.25 | 0.74 | 1.37 | 4.52 | 2.38 |
| 72 | 5.67 | bcc | 50 | 0.047 | 0.54 | 0.75 | 1.39 | 10.5 | 5.53 |

According to Table 4, in the examples in which the annealing temperature was suitably controlled to control the value of the larger one of A(Fe1)/A(Fe2) and A(Co1)/A(Co2) within 1.20 or more and 8.00 or less and the average crystal grain size within 2 nm or more and 30 nm or less, the p and Bs values greatly increased from those before annealing.

In contrast, in the comparative example in which the annealing temperature was too high, the larger one of A(Fe1)/A(Fe2) and A(Co1)/A(Co2) had a value exceeding 8.00 and the average crystal grain size exceeded 30 nm. As a result, the p value decreased and the Hc value increased from those before annealing.

### Experiment 5

Experiment 5 was carried out as in Experiment 1, except that the metal sputtering target was changed to change the composition of the nanogranular magnetic film as shown in Tables 5 to 9. Tables 5 to 9 show the results. Note that, in all Samples shown in Tables 5 to 9, it was confirmed that the value of V₁/(V₁+V₂) was 0.55.

TABLE 5

| | | Composition of | TS | Annealing | | | | | |
|---|---|---|---|---|---|---|---|---|---|
| Sample | Example/ | magnetic film | distance | temperature | A(Fe1) | A(Fe2) | A(Fe1)/ | A(Co1) | A(Co2) |
| No. | comparative example | (atomic ratio) | mm | ° C. | at % | at % | A(Fe2) | at % | at % |
| 73 | Comparative example | 79.6Fe - 20.4(SiO₂) | 90 | — | 83.4 | 71.4 | 1.17 | — | — |
| 74 | Comparative example | 79.6Fe - 20.4(SiO₂) | 90 | 300 | 96.8 | 10.6 | 9.13 | — | — |
| 75 | Comparative example | 79.6Fe - 20.4(SiO₂) | 140 | — | 82.8 | 71.8 | 1.15 | — | — |
| 76 | Example | 79.6Fe - 20.4(SiO₂) | 140 | 300 | 92.3 | 65.2 | 1.42 | — | — |
| 77 | Comparative example | 79.6(Fe_{0.8}Co_{0.2}) - 20.4(SiO₂) | 90 | — | 64.8 | 60.2 | 1.08 | 17.2 | 14.5 |
| 78 | Comparative example | 79.6(Fe_{0.8}Co_{0.2}) - 20.4(SiO₂) | 90 | 300 | 67.6 | 53.8 | 1.26 | 28.4 | 3.1 |
| 79 | Comparative example | 79.6(Fe_{0.8}Co_{0.2}) - 20.4(SiO₂) | 140 | — | 65.5 | 59.6 | 1.10 | 17.3 | 14.7 |
| 80 | Example | 79.6(Fe_{0.8}Co_{0.2}) - 20.4(SiO₂) | 140 | 300 | 66.4 | 53.9 | 1.23 | 27.7 | 4.6 |
| 7 | Comparative example | 79.6(Fe_{0.6}Co_{0.4}) - 20.4(SiO₂) | 90 | — | 49.3 | 45.3 | 1.09 | 33.7 | 29.1 |
| 9 | Comparative example | 79.6(Fe_{0.6}Co_{0.4}) - 20.4(SiO₂) | 90 | 300 | 54.2 | 30.8 | 1.76 | 43.0 | 4.7 |
| 10 | Comparative example | 79.6(Fe_{0.6}Co_{0.4}) - 20.4(SiO₂) | 140 | — | 49.1 | 44.5 | 1.10 | 34.3 | 29.3 |
| 12 | Example | 79.6(Fe_{0.6}Co_{0.4}) - 20.4(SiO₂) | 140 | 300 | 53.1 | 33.2 | 1.60 | 42.7 | 6.3 |
| 81 | Comparative example | 79.6(Fe_{0.2}Co_{0.8}) - 20.4(SiO₂) | 90 | — | 17.3 | 14.6 | 1.18 | 68.3 | 58.7 |
| 82 | Comparative example | 79.6(Fe_{0.2}Co_{0.8}) - 20.4(SiO₂) | 90 | 300 | 21.9 | 11.7 | 1.87 | 74.2 | 5.7 |
| 83 | Comparative example | 79.6(Fe_{0.2}Co_{0.8}) - 20.4(SiO₂) | 140 | — | 17.7 | 15.2 | 1.26 | 66.7 | 59.9 |
| 84 | Example | 79.6(Fe_{0.2}Co_{0.8}) - 20.4(SiO₂) | 140 | 300 | 19.2 | 13.5 | 1.42 | 67.8 | 12.3 |
| 85 | Comparative example | 80.7Co - 19.3(SiO₂) | 90 | — | — | — | — | 84.8 | 71.6 |
| 86 | Comparative example | 80.7Co - 19.3(SiO₂) | 90 | 300 | — | — | — | 97.1 | 8.2 |
| 87 | Comparative example | 80.7Co - 19.3(SiO₂) | 140 | — | — | — | — | 85.1 | 72.2 |
| 88 | Example | 80.7Co - 19.3(SiO₂) | 140 | 300 | — | — | — | 95.6 | 58.3 |

| | | | | Average | | | | | | |
|---|---|---|---|---|---|---|---|---|---|---|
| | | | | crystal | | | | | | |
| | | | | grain | | | | | | |
| Sample | A(Co1)/ | {A(Col)/A(Co2)}/ | Crystal | size | ρ | ρ | Bs | Bs | Hc | Hc |
| No. | A(Co2) | {A(Fe1)/A(Fe2)} | structure | nm | Ω · cm | ratio | T | ratio | Oe | ratio |
| 73 | — | — | bcc | 4 | 0.081 | — | 0.68 | — | 1.81 | — |
| 74 | — | — | bcc | 55 | 0.083 | 1.02 | 0.75 | 1.10 | 3.52 | 1.94 |
| 75 | — | — | bcc | 4 | 0.105 | — | 0.52 | — | 1.85 | — |
| 76 | — | — | bcc | 7 | 0.139 | 1.32 | 0.69 | 1.33 | 1.78 | 0.96 |
| 77 | 1.19 | 1.10 | bcc | 4 | 0.060 | — | 0.71 | — | 1.85 | — |
| 78 | 9.16 | 7.29 | bcc | 52 | 0.050 | 0.83 | 0.78 | 1.10 | 3.47 | 1.88 |
| 79 | 1.18 | 1.07 | bcc | 4 | 0.103 | — | 0.61 | — | 1.92 | — |
| 80 | 6.02 | 4.89 | bcc | 5 | 0.137 | 1.33 | 0.82 | 1.34 | 1.86 | 0.97 |
| 7 | 1.16 | 1.06 | bcc | 3 | 0.067 | — | 0.70 | — | 1.84 | — |
| 9 | 9.15 | 5.20 | bcc | 57 | 0.068 | 1.01 | 0.85 | 1.21 | 3.40 | 1.85 |
| 10 | 1.17 | 1.06 | bcc | 4 | 0.087 | — | 0.54 | — | 1.90 | — |
| 12 | 6.78 | 4.24 | bcc | 5 | 0.110 | 1.26 | 0.70 | 1.30 | 1.75 | 0.92 |
| 81 | 1.16 | 0.98 | bcc | 6 | 0.072 | — | 0.73 | — | 1.88 | — |
| 82 | 13.02 | 6.95 | bcc | 51 | 0.081 | 1.13 | 0.85 | 1.16 | 3.56 | 1.89 |
| 83 | 1.11 | 0.96 | bcc | 4 | 0.127 | — | 0.62 | — | 1.92 | — |
| 84 | 5.51 | 3.88 | bcc | 6 | 0.173 | 1.36 | 0.85 | 1.37 | 1.85 | 0.96 |
| 85 | 1.18 | — | hcp | 5 | 0.060 | — | 0.66 | — | 1.79 | — |
| 86 | 11.84 | — | hcp | 58 | 0.058 | 0.97 | 0.72 | 1.09 | 3.34 | 1.87 |
| 87 | 1.18 | — | hcp | 5 | 0.087 | — | 0.51 | — | 1.83 | — |
| 88 | 1.64 | — | hcp | 6 | 0.105 | 1.21 | 0.67 | 1.31 | 1.78 | 0.97 |

TABLE 6

| | | Composition of | TS | Annealing | | | | |
|---|---|---|---|---|---|---|---|---|
| Sample | Example/ | magnetic film | distance | temperature | A(Fe1) | A(Fe2) | A(Fe1)/ | A(Ni1) |
| No. | comparative example | (atomic ratio) | mm | ° C. | at % | at % | A(Fe2) | at % |
| 89 | Comparative example | 79.6(Fe_{0.55}Ni_{0.45}) - 20.4(SiO₂) | 90 | — | 48.1 | 41.3 | 1.16 | 36.9 |
| 90 | Comparative example | 79.6(Fe_{0.55}Ni_{0.45}) - 204(SiO₂) | 90 | 300 | 51.3 | 36.8 | 1.39 | 46.1 |
| 91 | Comparative example | 79.6(Fe_{0.55}Ni_{0.45}) - 204(SiO₂) | 140 | — | 48.1 | 41.7 | 1.15 | 37.4 |
| 92 | Example | 79.6(Fe_{0.55}Ni_{0.45}) - 20.4(SiO₂) | 140 | 300 | 50.9 | 37.7 | 1.35 | 44.7 |

| | | | | Average | | | | | | |
|---|---|---|---|---|---|---|---|---|---|---|
| | | | | crystal | | | | | | |
| | | A(Ni1)/ | | grain | | | | | | |
| Sample | A(Ni2) | A(Ni2) | Crystal | size | ρ | ρ | Bs | Bs | | Hc |
| No. | at % | — | structure | nm | Ω · cm | ratio | T | ratio | Hc | ratio |
| 89 | 31.4 | 1.18 | bcc | 3 | 0.077 | — | 0.63 | — | 1.77 | — |
| 90 | 3.8 | 12.13 | bcc | 54 | 0.074 | 0.96 | 0.68 | 1.08 | 3.78 | 2.14 |
| 91 | 31.7 | 1.18 | bcc | 2 | 0.128 | — | 0.51 | — | 1.86 | — |
| 92 | 5.7 | 7.84 | bcc | 2 | 0.172 | 1.34 | 0.69 | 1.35 | 1.74 | 0.94 |

TABLE 7

| | | Composition of | TS | | | |
|---|---|---|---|---|---|---|
| Sample | Example/ | magnetic film | distance | Annealing | A(Fe1) | A(Fe2) |
| No. | comparative example | (atomic ratio) | mm | temperature | at % | at % |
| 73 | Comparative example | 79.6Fe - 20.4(SiO₂) | 90 | — | 83.4 | 71.4 |
| 74 | Comparative example | 79.6Fe - 20.4(SiO₂) | 90 | 300 | 96.8 | 10.6 |
| 75 | Comparative example | 79.6Fe - 20.4(SiO₂) | 140 | — | 82.8 | 71.8 |
| 76 | Example | 79.6Fe - 20.4(SiO₂) | 140 | 300 | 92.3 | 65.2 |
| 93 | Comparative example | 79.6(Fe_{0.75}B_{0.25}) - 20.4(SiO₂) | 90 | — | 73.5 | 64.5 |
| 94 | Comparative example | 79.6(Fe_{0.75}B_{0.25}) - 20.4(SiO₂) | 90 | 300 | 90.3 | 8.9 |
| 95 | Comparative example | 79.6(Fe_{0.75}B_{0.25}) - 20.4(SiO₂) | 140 | — | 76.6 | 64.8 |
| 96 | Example | 79.6(Fe_{0.75}B_{0.25}) - 20.4(SiO₂) | 140 | 300 | 88.4 | 58.8 |
| 97 | Comparative example | 79.6(Fe_{0.8}B_{0.1}Si_{0.1}) - 20.4(SiO₂) | 90 | — | 79.5 | 69.4 |
| 98 | Comparative example | 79.6(Fe_{0.8}B_{0.1}Si_{0.1}) - 20.4(SiO₂) | 90 | 300 | 88.4 | 10.8 |
| 99 | Comparative example | 79.6(Fe_{0.8}B_{0.1}Si_{0.1}) - 20.4(SiO₂) | 140 | — | 76.2 | 65.6 |
| 100 | Example | 79.6(Fe_{0.8}B_{0.1}Si_{0.1}) - 20.4(SiO₂) | 140 | 300 | 85.6 | 14.7 |
| 101 | Comparative example | 79.6(Fe_{0.85}P_{0.15}) - 20.4(SiO₂) | 90 | — | 72.6 | 62.2 |
| 102 | Comparative example | 79.6(Fe_{0.85}P_{0.15}) - 20.4(SiO₂) | 90 | 300 | 88.4 | 10.8 |
| 103 | Comparative example | 79.6(Fe_{0.85}P_{0.15}) - 20.4(SiO₂) | 140 | — | 74.2 | 64.6 |
| 104 | Example | 79.6(Fe_{0.85}P_{0.15}) - 20.4(SiO₂) | 140 | 300 | 85.6 | 14.7 |
| 105 | Comparative example | 79.6(Fe_{0.85}C_{0.15}) - 20.4(SiO₂) | 90 | — | 71.5 | 62.0 |
| 106 | Comparative example | 79.6(Fe_{0.85}C_{0.15}) - 20.4(SiO₂) | 90 | 300 | 90.6 | 9.7 |
| 107 | Comparative example | 79.6(Fe_{0.85}C_{0.15}) - 20.4(SiO₂) | 140 | — | 73.5 | 64.2 |
| 108 | Example | 79.6(Fe_{0.85}C_{0.15}) - 20.4(SiO₂) | 140 | 300 | 86.4 | 17.9 |
| 109 | Comparative example | 79.6(Fe_{0.98}Ge_{0.02}) - 20.4(SiO₂) | 90 | — | 85.2 | 76.6 |
| 110 | Comparative example | 79.6(Fe_{0.98}Ge_{0.02}) - 20.4(SiO₂) | 90 | 300 | 95.6 | 8.3 |
| 111 | Comparative example | 79.6(Fe_{0.98}Ge_{0.02}) - 20.4(SiO₂) | 140 | — | 84.7 | 77.3 |
| 112 | Example | 79.6(Fe_{0.98}Ge_{0.02}) - 20.4(SiO₂) | 140 | 300 | 93.4 | 15.5 |

| | | | Average | | | | | | |
|---|---|---|---|---|---|---|---|---|---|
| | | | crystal | | | | | | |
| | | | grain | | | | | | |
| Sample | A(Fe1)/ | Crystal | size | | ρ | Bs | Bs | Hc | Hc |
| No. | A(Fe2) | structure | nm | ρ | ratio | T | ratio | Oe | ratio |
| 73 | 1.17 | bcc | 4 | 0.081 | — | 0.68 | — | 1.81 | — |
| 74 | 9.13 | bcc | 55 | 0.083 | 1.02 | 0.75 | 1.10 | 3.52 | 1.94 |
| 75 | 1.15 | bcc | 4 | 0.105 | — | 0.52 | — | 1.85 | — |
| 76 | 1.42 | bcc | 7 | 0.139 | 1.32 | 0.69 | 1.33 | 1.78 | 0.96 |
| 93 | 1.14 | bcc | 4 | 0.088 | — | 0.58 | — | 1.68 | — |
| 94 | 10.15 | bcc | 56 | 0.086 | 0.98 | 0.67 | 1.16 | 2.87 | 1.71 |
| 95 | 1.18 | bcc | 4 | 0.153 | — | 0.49 | — | 1.73 | — |
| 96 | 1.50 | bcc | 8 | 0.202 | 1.32 | 0.66 | 1.35 | 1.68 | 0.97 |
| 97 | 1.15 | bcc | 5 | 0.097 | — | 0.61 | — | 1.70 | — |
| 98 | 8.19 | bcc | 58 | 0.095 | 0.98 | 0.72 | 1.18 | 2.94 | 1.73 |
| 99 | 1.16 | bcc | 4 | 0.162 | — | 0.50 | — | 1.76 | — |
| 100 | 5.82 | bcc | 5 | 0.217 | 1.34 | 0.70 | 1.40 | 1.72 | 0.98 |
| 101 | 1.17 | bcc | 6 | 0.080 | — | 0.61 | — | 1.69 | — |
| 102 | 8.19 | bcc | 55 | 0.082 | 1.03 | 0.67 | 1.10 | 3.37 | 1.99 |
| 103 | 1.15 | bcc | 4 | 0.137 | — | 0.50 | — | 1.75 | — |
| 104 | 5.82 | bcc | 6 | 0.181 | 1.32 | 0.65 | 1.30 | 1.70 | 0.97 |
| 105 | 1.15 | bcc | 5 | 0.076 | — | 0.57 | — | 1.64 | — |
| 106 | 9.34 | bcc | 57 | 0.082 | 1.08 | 0.68 | 1.19 | 3.59 | 2.19 |
| 107 | 1.14 | bcc | 6 | 0.133 | — | 0.48 | — | 1.71 | — |
| 108 | 4.83 | bcc | 6 | 0.178 | 1.34 | 0.66 | 1.38 | 1.68 | 0.98 |
| 109 | 1.11 | bcc | 7 | 0.057 | — | 0.69 | — | 1.80 | — |
| 110 | 11.52 | bcc | 58 | 0.055 | 0.96 | 0.75 | 1.09 | 3.75 | 2.08 |
| 111 | 1.10 | bcc | 6 | 0.098 | — | 0.58 | — | 1.88 | — |
| 112 | 6.03 | bcc | 8 | 0.131 | 1.34 | 0.77 | 1.33 | 1.81 | 0.96 |

TABLE 8

| | | Composition of | TS | Annealing | | |
|---|---|---|---|---|---|---|
| Sample | Example/ | magnetic film | distance | temperature | A(Fe1) | A(Fe2) |
| No. | comparative example | (atomic ratio) | mm | ° C. | at % | at % |
| 73 | Comparative example | 79.6Fe - 20.4(SiO₂) | 90 | — | 83.4 | 71.4 |
| 74 | Comparative example | 79.6Fe - 20.4(SiO₂) | 90 | 300 | 96.8 | 10.6 |
| 75 | Comparative example | 79.6Fe - 20.4(SiO₂) | 140 | — | 82.8 | 71.8 |
| 76 | Example | 79.6Fe - 20.4(SiO₂) | 140 | 300 | 92.3 | 65.2 |
| 113 | Comparative example | 79.6(Fe_{0.98}Cr_{0.02}) - 20.4(SiO₂) | 90 | — | 86.3 | 76.6 |
| 114 | Comparative example | 79.6(Fe_{0.98}Cr_{0.02}) - 20.4(SiO₂) | 90 | 300 | 95.3 | 10.4 |
| 115 | Comparative example | 79.6(Fe_{0.98}Cr_{0.02}) - 20.4(SiO₂) | 140 | — | 86.9 | 75.8 |
| 16 | Example | 79.6(Fe_{0.98}Cr_{0.02}) - 20.4(SiO₂) | 140 | 300 | 93.4 | 16.8 |
| 117 | Comparative example | 79.6(Fe_{0.98}V_{0.02}) - 20.4(SiO₂) | 90 | — | 87.4 | 77.7 |
| 118 | Comparative example | 79.6(Fe_{0.98}V_{0.02}) - 20.4(SiO₂) | 90 | 300 | 96.2 | 11.5 |
| 119 | Comparative example | 79.6(Fe_{0.98}V_{0.02}) - 20.4(SiO²) | 140 | — | 86.6 | 74.3 |
| 120 | Example | 79.6(Fe_{0.98}V_{0.02}) - 20.4(SiO₂) | 140 | 300 | 94.7 | 22.6 |
| 121 | Comparative example | 79.6(Fe_{0.98}Mo_{0.02}) - 20.4(SiO₂) | 90 | — | 88.3 | 75.6 |
| 122 | Comparative example | 79.6(Fe_{0.98}Mo_{0.02}) - 20.4(SiO₂) | 90 | 300 | 94.3 | 11.0 |
| 123 | Comparative example | 79.6(Fe_{0.98}Mo_{0.02}) - 20.4(SiO₂) | 140 | — | 85.6 | 74.9 |
| 124 | Example | 79.6(Fe_{0.98}Mo_{0.02}) - 20.4(SiO₂) | 140 | 300 | 93.6 | 32.1 |
| 125 | Comparative example | 79.6(Fe_{0.98}Zr_{0.02}) - 20.4(SiO₂) | 90 | — | 84.2 | 76.2 |
| 126 | Comparative example | 79.6(Fe_{0.98}Zr_{0.02}) - 20.4(SiO₂) | 90 | 300 | 93.6 | 11.2 |
| 127 | Comparative example | 79.6(Fe_{0.98}Zr_{0.02}) - 20.4(SiO₂) | 140 | — | 85.4 | 73.7 |
| 128 | Example | 79.6(Fe_{0.98}Zr_{0.02}) - 20.4(SiO₂) | 140 | 300 | 95.1 | 29.3 |
| 129 | Comparative example | 79.6(Fe_{0.98}Nb_{0.02}) - 20.4(SiO₂) | 90 | — | 87.9 | 74.4 |
| 130 | Comparative example | 79.6(Fe_{0.98}Nb_{0.02}) - 20.4(SiO₂) | 90 | 300 | 96.6 | 11.8 |
| 131 | Comparative example | 79.6(Fe_{0.98}Nb_{0.02}) - 20.4(SiO₂) | 140 | — | 86.2 | 72.9 |
| 132 | Example | 79.6(Fe_{0.98}Nb_{0.02}) - 20.4(SiO₂) | 140 | 300 | 96.3 | 33.4 |

| | | | Average | | | | | | |
|---|---|---|---|---|---|---|---|---|---|
| | | | crystal | | | | | | |
| | | | grain | | | | | | |
| Sample | A(Fe1)/ | Crystal | size | ρ | ρ | Bs | Bs | Hc | Hc |
| No. | A(Fe2) | structure | nm | Ω · cm | ratio | T | ratio | Oe | ratio |
| 73 | 1.17 | bcc | 4 | 0.081 | — | 0.68 | — | 1.81 | — |
| 74 | 9.13 | bcc | 55 | 0.083 | 1.02 | 0.75 | 1.10 | 3.52 | 1.94 |
| 75 | 1.15 | bcc | 4 | 0.105 | — | 0.52 | — | 1.85 | — |
| 76 | 1.42 | bcc | 7 | 0.139 | 1.32 | 0.69 | 1.33 | 1.78 | 0.96 |
| 113 | 1.13 | bcc | 4 | 0.062 | — | 0.68 | — | 1.78 | — |
| 114 | 9.16 | bcc | 51 | 0.071 | 1.15 | 0.78 | 1.15 | 3.03 | 1.70 |
| 115 | 1.15 | bcc | 4 | 0.100 | — | 0.56 | — | 1.86 | — |
| 16 | 5.56 | bcc | 7 | 0.137 | 1.37 | 0.74 | 1.32 | 1.82 | 0.98 |
| 117 | 1.12 | bcc | 4 | 0.058 | — | 0.64 | — | 1.75 | — |
| 118 | 8.37 | bcc | 56 | 0.059 | 1.02 | 0.71 | 1.11 | 3.24 | 1.85 |
| 119 | 1.17 | bcc | 3 | 0.097 | — | 0.52 | — | 1.82 | — |
| 120 | 4.19 | bcc | 4 | 0.126 | 1.30 | 0.74 | 1.42 | 1.76 | 0.97 |
| 121 | 1.17 | bcc | 6 | 0.059 | — | 0.63 | — | 1.72 | — |
| 122 | 8.57 | bcc | 59 | 0.058 | 0.98 | 0.75 | 1.19 | 3.36 | 1.95 |
| 123 | 1.14 | bcc | 5 | 0.099 | — | 0.54 | — | 1.81 | — |
| 124 | 2.92 | bcc | 6 | 0.134 | 1.35 | 0.76 | 1.41 | 1.78 | 0.98 |
| 125 | 1.10 | bcc | 4 | 0.060 | — | 0.68 | — | 1.77 | — |
| 126 | 8.36 | bcc | 60 | 0.071 | 1.18 | 0.81 | 1.19 | 4.02 | 2.27 |
| 127 | 1.16 | bcc | 4 | 0.100 | — | 0.56 | — | 1.85 | — |
| 128 | 3.25 | bcc | 4 | 0.135 | 1.35 | 0.77 | 1.38 | 1.79 | 0.97 |
| 129 | 1.18 | bcc | 7 | 0.059 | — | 0.64 | — | 1.73 | — |
| 130 | 8.19 | bcc | 52 | 0.057 | 0.97 | 0.72 | 1.13 | 3.78 | 2.18 |
| 131 | 1.18 | bcc | 7 | 0.098 | — | 0.55 | — | 1.82 | — |
| 132 | 2.88 | bcc | 9 | 0.135 | 1.38 | 0.75 | 1.36 | 1.80 | 0.99 |

TABLE 9

| | | Composition of | TS | Annealing | | |
|---|---|---|---|---|---|---|
| Sample | Example/ | magnetic film | distance | temperature | A(Fe1) | A(Fe2) |
| No | comparative example | (atomic ratio) | mm | ° C. | at % | at % |
| 133 | Comparative example | 79.6(Fe_{0.98}Ti_{0.02}) - 20.4(SiO₂) | 90 | — | 86.5 | 75.2 |
| 134 | Comparative example | 79.6(Fe_{0.98}Ti_{0.02}) - 20.4(SiO₂) | 90 | 300 | 96.8 | 10.3 |
| 135 | Comparative example | 79.6(Fe_{0.98}Ti_{0.02}) - 20.4(SiO₂) | 140 | — | 84.7 | 74.8 |
| 136 | Example | 79.6(Fe_{0.98}Ti_{0.02}) - 20.4(SiO₂) | 140 | 300 | 94.3 | 23.4 |
| 137 | Comparative example | 79.6(Fe_{0.98}Mn_{0.02}) - 20.4(SiO₂) | 90 | — | 83.9 | 76.4 |
| 138 | Comparative example | 79.6(Fe_{0.98}Mn_{0.02}) - 20.4(SiO₂) | 90 | 300 | 93.5 | 9.4 |
| 139 | Comparative example | 79.6(Fe_{0.98}Mn_{0.02}) - 20.4(SiO₂) | 140 | — | 85.2 | 74.0 |
| 140 | Example | 79.6(Fe_{0.98}Mn_{0.02}) - 20.4(SiO₂) | 140 | 300 | 93.1 | 18.5 |
| 141 | Comparative example | 79.6(Fe_{0.98}Zn_{0.02}) - 20.4(SiO₂) | 90 | — | 84.6 | 77.4 |
| 142 | Comparative example | 79.6(Fe_{0.98}Zn_{0.02}) - 20.4(SiO₂) | 90 | 300 | 96.1 | 9.2 |
| 143 | Comparative example | 79.6(Fe_{0.98}Zn_{0.02}) - 20.4(SiO₂) | 140 | — | 85.7 | 77.8 |
| 144 | Example | 79.6(Fe_{0.98}Zn_{0.02}) - 20.4(SiO₂) | 140 | 300 | 96.3 | 20.4 |
| 145 | Comparative example | 79.6(Fe_{0.98}Al_{0.02}) - 20.4(SiO₂) | 90 | — | 86.9 | 73.2 |
| 146 | Comparative example | 79.6(Fe_{0.98}Al_{0.02}) - 20.4(SiO₂) | 90 | 300 | 95.2 | 11.6 |
| 147 | Comparative example | 79.6(Fe_{0.98}Al_{0.02}) - 20.4(SiO₂) | 140 | — | 84.3 | 77.9 |
| 148 | Example | 79.6(Fe_{0.98}Al_{0.02}) - 20.4(SiO₂) | 140 | 300 | 91.5 | 28.0 |
| 149 | Comparative example | 79.6(Fe_{0.98}Cu_{0.02}) - 20.4(SiO₂) | 90 | — | 82.9 | 72.2 |
| 150 | Comparative example | 79.6(Fe_{0.98}Cu_{0.02}) - 20.4(SiO₂) | 90 | 300 | 95.9 | 10.1 |
| 151 | Comparative example | 79.6(Fe_{0.98}Cu_{0.02}) - 20.4(SiO₂) | 140 | — | 83.5 | 75.0 |
| 152 | Example | 79.6(Fe_{0.98}Cu_{0.02}) - 20.4(SiO₂) | 140 | 300 | 92.3 | 22.3 |
| 153 | Comparative example | 79.6(Fe_{0.98}Y_{0.02}) - 20.4(SiO₂) | 90 | — | 85.5 | 73.1 |
| 154 | Comparative example | 79.6(Fe_{0.98}Y_{0.02}) - 20.4(SiO₂) | 90 | 300 | 94.2 | 11.2 |
| 155 | Comparative example | 79.6(Fe_{0.98}Y_{0.02}) - 20.4(SiO₂) | 140 | — | 83.0 | 71.2 |
| 156 | Example | 79.6(Fe_{0.98}Y_{0.02}) - 20.4(SiO₂) | 140 | 300 | 93.6 | 21.1 |

| | | | Average | | | | | | |
|---|---|---|---|---|---|---|---|---|---|
| | | | crystal | | | | | | |
| | A(Fe1)/ | | grain | | | | | | |
| Sample | A(Fe2) | Crystal | size | ρ | ρ | Bs | Bs | Hc | Hc |
| No | — | structure | nm | Ω · cm | ratio | T | ratio | Oe | ratio |
| 133 | 1.15 | bcc | 8 | 0.058 | — | 0.62 | — | 1.71 | — |
| 134 | 9.40 | bcc | 52 | 0.064 | 1.10 | 0.70 | 1.13 | 3.35 | 1.96 |
| 135 | 1.13 | bcc | 7 | 0.097 | — | 0.51 | — | 1.83 | — |
| 136 | 4.03 | bcc | 9 | 0.132 | 1.36 | 0.71 | 1.39 | 1.78 | 0.97 |
| 137 | 1.10 | bcc | 4 | 0.056 | — | 0.61 | — | 1.70 | — |
| 138 | 9.95 | bcc | 56 | 0.067 | 1.20 | 0.69 | 1.13 | 3.04 | 1.79 |
| 139 | 1.15 | bcc | 3 | 0.096 | — | 0.51 | — | 1.85 | — |
| 140 | 5.03 | bcc | 5 | 0.126 | 1.31 | 0.70 | 1.37 | 1.81 | 0.98 |
| 141 | 1.09 | bcc | 6 | 0.055 | — | 0.67 | — | 1.77 | — |
| 142 | 10.45 | bcc | 52 | 0.057 | 1.04 | 0.75 | 1.12 | 3.38 | 1.91 |
| 143 | 1.10 | bcc | 4 | 0.093 | — | 0.57 | — | 1.88 | — |
| 144 | 4.72 | bcc | 7 | 0.130 | 1.40 | 0.76 | 1.33 | 1.82 | 0.97 |
| 145 | 1.19 | bcc | 4 | 0.054 | — | 0.68 | — | 1.79 | — |
| 146 | 8.21 | bcc | 59 | 0.052 | 0.96 | 0.78 | 1.15 | 3.87 | 2.16 |
| 147 | 1.08 | bcc | 4 | 0.091 | — | 0.57 | — | 1.87 | — |
| 148 | 3.27 | bcc | 6 | 0.128 | 1.41 | 0.75 | 1.32 | 1.80 | 0.96 |
| 149 | 1.15 | bcc | 5 | 0.052 | — | 0.69 | — | 1.79 | — |
| 150 | 9.50 | bcc | 58 | 0.062 | 1.19 | 0.77 | 1.12 | 4.09 | 2.28 |
| 151 | 1.11 | bcc | 5 | 0.088 | — | 0.58 | — | 1.88 | — |
| 152 | 4.14 | bcc | 6 | 0.119 | 1.35 | 0.79 | 1.36 | 1.77 | 0.94 |
| 153 | 1.17 | bcc | 4 | 0.059 | — | 0.62 | — | 1.71 | — |
| 154 | 8.41 | bcc | 57 | 0.061 | 1.03 | 0.71 | 1.15 | 4.13 | 2.42 |
| 155 | 1.17 | bcc | 5 | 0.099 | — | 0.52 | — | 1.84 | — |
| 156 | 4.44 | bcc | 8 | 0.135 | 1.36 | 0.72 | 1.38 | 1.77 | 0.96 |

According to Tables 5 to 9, in the examples in which the TS distance was longer than 90 mm and the annealing temperature was 300° C. for sufficient annealing, the largest one of A(Fe1)/A(Fe2), A(Co1)/A(Co2), and A(Ni1)/A(Ni2) had a value of 1.20 or more and 8.00 or less and the average crystal grain size was 2 nm or more and 30 nm or less, even when the composition of the nanogranular magnetic film was changed as shown in Tables 5 to 9. In these examples, the p and Bs values greatly increased from those before annealing.

### NUMERICAL REFERENCES

1 . . . nanogranular magnetic film
11 . . . first phase
12 . . . second phase

What is claimed is:

1. A nanogranular magnetic film comprising a structure including first phases comprised of nano-domains dispersed in a second phase, wherein
the first phases and the second phase comprise at least one selected from the group consisting of Fe, Co, and Ni;
the second phase comprises at least one selected from the group consisting of O, N, and F more than the first phases do;
a ratio of a volume of the first phases to a total volume of the first phases and the second phase is 65% or less;
a largest one of A(Fe1)/A(Fe2), A(Co1)/A(Co2), and A(Ni1)/A(Ni2) has a value of 1.20 or more and 8.00 or less, provided that a percentage of Fe in the first phases is A(Fe1), a percentage of Fe in the second phase is A(Fe2), a percentage of Co in the first phases is A(Co1), a percentage of Co in the second phase is A(Co2), a percentage of Ni in the first phases is A(Ni1), and a percentage of Ni in the second phase is A(Ni2); and
the first phases comprised of the nano-domains have an average size of 2 nm or more and 30 nm or less.

2. The nanogranular magnetic film according to claim 1, wherein the first phases comprised of the nano-domains have an average size of 2 nm or more and 15 nm or less.

3. The nanogranular magnetic film according to claim 1, wherein the first phases have a bcc crystal structure.

4. The nanogranular magnetic film according to claim 1, wherein
the nanogranular magnetic film comprises Fe and Co; and
{A(Co1)/A(Co2)}/{A(Fe1)/A(Fe2)}>1.05 is satisfied.

5. The nanogranular magnetic film according to claim 1, wherein
the nanogranular magnetic film comprises Fe and Co; and
{A(Co1)/A(Co2)}/{A(Fe1)/A(Fe2)}>2.00 is satisfied.

6. An electronic component comprising the nanogranular magnetic film according to claim 1.
